(19) United States
(12) Patent Application Publication
(10) Pub. No.: US 2026/0004673 A1
(43) Pub. Date: Jan. 1, 2026

(54) SYSTEM AND PROCESS FOR SECURE ONLINE TESTING WITH MINIMAL GROUP DIFFERENCES

(71) Applicant: ACUITY INSIGHTS INC., Toronto (CA)

(72) Inventors: Harold REITER, Toronto (CA); Cole WALSH, Toronto (CA); Tobin EDWARDS, Toronto (CA); Kelly DORE, Toronto (CA); Gill SITARENIOS, Toronto (CA); Heather DAVIDSON, Toronto (CA)

(21) Appl. No.: 19/106,955

(22) PCT Filed: Aug. 26, 2022
(86) PCT No.: PCT/CA2022/051301

§ 371 Date: Feb. 26, 2025

(51) Int. Cl. G09B 7/02; G09B 5/06; H04L 67/02

(52) U.S. Cl. CPC G09B 7/02; G09B 5/06; H04L 67/02

(57) ABSTRACT

Embodiments described herein relate to computer systems and methods for online testing. Systems and methods can be implemented by a modular computer architecture with multiple services for online testing. Embodiments described herein relate to systems and methods for secure online testing with minimal group differences using audiovisual responses. Embodiments described herein relate to systems and methods for secure online testing with hybrid rating or automated ratings.

### FIELD

The improvements generally relate to the field of computer systems, audio and video data processing, natural language processing, networking, and distributed hardware. In an aspect, the improvements relate to distributed computer systems for converting onsite testing to secure online testing. In another aspect, the improvements relate to distributed computer systems for secure online testing with minimal group differences.

### INTRODUCTION

Standardized tests measure various cognitive and/or technical and/or non-cognitive skills (including but not limited to situational judgment tests (SJTs) measuring professionalism, situational awareness, and social intelligence) based on examinees' actions for hypothetical real-life scenarios. Standardized tests can be administered at onsite human-invigilated test centres, including computer test centres. However, there exists a need for computer and technical solutions for converting onsite testing to secure online testing and for providing an online test platform. There also exists a need for computer and technical solutions for converting sub-optimally secure online testing to optimally secure online testing.

Embodiments described herein relate to a distributed computer hardware environment to support secure, resource-efficient online testing. The process of converting onsite and online testing to optimally secure, resource-efficient online testing with minimal group differences may require conversion of different components, such as, for example: (1) test equipment site and infrastructure, (2) question representation format, (3) response format, (4) scoring methodology, and (5) authentication and monitoring procedures.

Moderate to large group differences on standardized tests have been attributed to differences in educational opportunities. There are many avenues in which this occurs. Selected-response (closed-response, e.g. multiple choice question) tests may favour those with more exposure to such tests who have developed greater test gamesmanship; written stems (question preambles) may favour those with better reading comprehension; testing for achievement rather than ability (e.g. knowledge over reasoning) may favour those from better educational institutions; constructed-response (open-response, e.g. short essay answer) tests may favour those with better writing skills. As an illustrative example, there may be domestic versus foreign group differences moderated by response format.

Embodiments described herein provide distributed computer systems and processes for secure online testing with minimal group differences. Group differences may decrease when moving from selected-response to written constructed-response to audiovisual constructed-response.

Embodiments described herein can replace text-based item stems (or scenarios) for cognitive tests and response options to pictographic and/or visual formats. Stems or scenarios/preambles for cognitive tests are lead ups to questions to provide background and context for the questions. Selected response formats can be replaced with constructed audio or audiovisual format, with or without complementary selected responses. Embodiments described herein can use natural language processing for automated test evaluation or ratings. Pre-set machine-readable scoring can be replaced with human ratings augmented by natural language processing for high-stakes testing, or natural language processing alone for low-stakes testing. Embodiments described herein provide distributed computer systems and processes for secure online testing and assessment, and improvements thereto. For example, onsite and online test-taker authentication or monitoring can be converted to voice or voice plus facial recognition of audio, video, or audiovisual responses.

### SUMMARY

In an aspect, embodiments described herein provide systems and processes for secure online testing with minimal group differences. In another aspect, embodiments described herein provide systems and processes to convert onsite testing and sub-optimally secure online testing to optimally secure online testing with minimal group differences.

In an aspect, embodiments described herein provide systems and processes for online assessment or testing tools with constructed-response tests delivered and rated online using video-based responses. In another aspect, embodiments described herein provide improvements to online assessment tool with audio/video test responses. In an further aspect, embodiments described herein provide systems and processes to convert any test to the online environment with authentication and monitoring of the test taker. In an aspect, embodiments described herein provide systems and processes for audio/video processing and facial recognition for authentication and monitoring of online testing.

In accordance with an aspect, there is provided a computer system for online testing. The system has: a plurality of client web applications comprising an applicant portal, an administrator portal, a proctor portal, and a rater portal; a plurality of application services comprising an exam application programming interface service, a content application programming interface service, a proctor application programming interface service, a rating application programming interface service, an administrator application programming interface service, and account application programming interface service; an application programming interface gateway to transmit messages and exchange data between the plurality of client web applications and the plurality of application services; a plurality of domain services comprising an exam service, a content service, a proctor service, a rating service, an administrator service, and account service; a message queue service for coordinating messages between the plurality of application services and the plurality of domain services. The applicant portal is configured to provide an applicant interface to provide an exam for an applicant and collect response data for the exam, wherein the exam service and the exam application programming interface service compile the exam for the applicant, the exam comprising a test of a collection of scenarios with at least a subset of scenarios being audiovisual response scenarios, wherein the content application programming interface service and the content service delivers content for the exam, the content for the exam comprising audiovisual content, wherein the applicant portal is configured to provide the audiovisual content at the applicant interface. The proctor portal is configured to provide a proctor interface that monitors the applicant portal during the exam. The rater portal is configured to provide a rater interface that provides the response data for the exam and collects rating data for the response data for the exam, wherein the rater portal is configured to compute a rating for the exam using the rating data.

In some embodiments, the application services and domain services are implemented by at least one physical machine and at least one worker node, the physical machine providing a plurality of virtual machines corresponding to the plurality of application services, the worker node providing core compute resources and serve functions for the application services and the domain services.

In some embodiments, the system has an auto-scaling cluster with a control plane network for an auto-scaling controller node group and a data plane network for an auto-scaling worker node group, the control plane network being a set of services running on nodes that communicate with worker nodes of the auto-scaling worker node group, the data plane network providing communication between the services and implementing functionality of the services, wherein the auto-scaling cluster scales nodes of the groups in response to requests by the application services and the domain services, wherein the worker nodes of the worker node group provide core compute resources and serve functions of the services.

In some embodiments, the system has an authentication service, wherein the applicant portal authenticates the applicant using the authentication service prior to providing the exam to the applicant interface.

In some embodiments, the test is a constructed-response test, wherein the response data comprises audiovisual constructed-response data and wherein the applicant portal is configured to collect the audiovisual constructed-response data.

In some embodiments, the rater portal is configured to provide the audiovisual constructed-response data at the rater interface.

In some embodiments, the exam comprises a plurality of scenarios, wherein a first set of response data relates to a first set of scenarios, and a second set of response data relates to a second set of scenarios, wherein the rater portal provides the rater interface with the first set of response data and collects rating data for the first set of response data, wherein the rating service automatically generates the second set of response data using a natural language processing service, wherein the rating service generates a hybrid rating for the applicant using the first set of response data and the second set of response data.

In some embodiments, the rating service uses a natural language processing service to automatically generate rating data for at least a portion of the response data for the exam.

In some embodiments, the proctor service uses a face detection service and/or voice detection service to monitor the exam at the applicant portal.

In some embodiments, the exam involves multiple scenarios, each scenario associated with one or more aspects, each scenario having one or more questions for testing the one or more aspects, each of the one or more questions having one or more corresponding response items of the response data, wherein the rating service generates rating data for a scenario by combining rating data for the corresponding response items to the one or more questions of the respective scenario.

In some embodiments, the exam service defines parameters for exam length required to meet test reliability standards.

In some embodiments, the exam involves at least one scenario having one or more questions and one or more corresponding response items, wherein the exam service converts the one or more questions into a question representation format and the one or more corresponding response items into a response representation format for the audiovisual response scenarios to minimize group differences.

In some embodiments, the rating service computes group difference measurements for the exam by processing the rating data and applicant data, wherein the rating service can define different group difference ranges to indicate negligible, small, moderate and large group differences.

In some embodiments, the exam service provides the audiovisual response scenarios by converting a response format to a constructed audiovisual response format.

In some embodiments, the exam service is configured to compile the exam using exam portal to receive selected scenario and question items for the exam and compile the selected scenario and question items into the exam.

In some embodiments, the proctor service and the proctor portal provide an test support interface to provide test support for applicant portal.

In another aspect, there is provided a computer system for online testing. The system has a memory; a processor coupled to the memory programmed with executable instructions, the instructions including an interface for an online test comprising audiovisual response scenarios, each audiovisual response scenario having one or more corresponding questions, wherein the interface is configured to receive audiovisual response data for the questions; and an applicant electronic device having one or more input devices configured to collect the audiovisual response data and having a transmitter for transmitting the collected audiovisual response data to the interface.

In some embodiments, the test is a constructed-response test, wherein the audiovisual response data is audiovisual constructed-response data.

In some embodiments, the system has a rater electronic device for providing the collected audiovisual response data and collecting rating data corresponding to the audiovisual response data.

In some embodiments, the system has a rating service to automatically generate at least a portion rating data for the response data.

In some embodiments, the rating service communicates with a natural language processing service to automatically generate at least a portion of the rating data.

In some embodiments, the exam comprises a plurality of scenarios, wherein a first set of response data relates to a first set of scenarios, and a second set of response data relates to a second set of scenarios, wherein a rater portal provides a rater interface with the first set of response data and collects rating data for the first set of response data, wherein the rating service automatically generates the second set of response data using a natural language processing service, wherein the rating service generates a hybrid rating for the test using the first set of response data and the second set of response data.

In some embodiments, the proctor service monitors the test using a face detection service and/or voice detection service to monitor the applicant electronic device.

In some embodiments, the online test involves multiple scenarios, each scenario associated with one or more aspects, each scenario having one or more questions for testing the one or more aspects, each of the one or more questions having one or more corresponding response items of the response data, wherein the rating service generates rating data for a scenario by combining rating data for the corresponding response items to the one or more questions of the respective scenario.

In some embodiments, the processor defines parameters for exam length required to meet test reliability standards.

In some embodiments, the test involves at least one scenario having one or more questions and one or more corresponding response items, wherein the exam service converts the one or more questions into a question representation format and the one or more corresponding response items into a response representation format for the audiovisual response scenarios to minimize group differences.

In some embodiments, the processor computes group difference measurements for the online test by processing rating data for the responses and applicant data, wherein the processor can define different group difference ranges to indicate negligible, small, moderate and large group differences.

In some embodiments, the processor provides the audiovisual response scenarios by converting a response format to a constructed audiovisual response format.

In some embodiments, the processor is configured to generate the online test by receiving selected scenarios and question items and compiling the selected scenario and question items for the test.

In some embodiments, the processor provides an test support interface to provide test support for applicant electronic device.

In another aspect, there is provided a computer system for online testing. The system has: a memory; a processor coupled to the memory programmed with executable instructions, the instructions including an interface for an online test comprising scenarios and questions, wherein the interface is configured to receive response data; an applicant electronic device having one or more input devices configured to collect the audiovisual response data and having a transmitter for transmitting the collected response data to the interface; and a physical machine configured with a rating service to automatically generate rating data for the response data using a natural language processing service.

In some embodiments, the system has a rater electronic device for collecting human rating data for the response data, wherein the rating service computes hybrid rating data using the automatically generated rating data and the human rating data.

In some embodiments, the system has a rater electronic device for collecting human rating data for the response data, wherein the rating service correlates machine predicted ratings with the human rating data to evaluate reliability of the rating data or the human rating data.

In some embodiments, a response item has corresponding rating data comprising both human rating data and machine predicted rating data to evaluate reliability of the rating data.

In some embodiments, a first response item has corresponding human rating data and a second response item has corresponding machine predicted rating data to automate generation of at least a portion of the rating data.

In another aspect, there is provided non-transitory computer readable memory having recorded thereon statements and instructions for execution by a hardware processor to carry out operations for online testing comprising: providing a plurality of application services comprising an exam application programming interface service, a content application programming interface service, a proctor application programming interface service, a rating application programming interface service, an administrator application programming interface service, and account application programming interface service; providing a plurality of domain services comprising an exam service, a content service, a proctor service, a rating service, an administrator service, and account service; providing a message queue service for coordinating messages between the plurality of application services and the plurality of domain services; providing an applicant interface to serve an exam for an applicant and collect response data for the exam, wherein the exam service and the exam application programming interface service compile the exam for the applicant, the exam comprising a test of a collection of scenarios with at least a subset of scenarios being audiovisual response scenarios, wherein the content application programming interface service and the content service delivers content for the exam, the content for the exam comprising audiovisual content, wherein the applicant portal is configured to provide the audiovisual content at the applicant interface; providing a proctor interface that monitors the applicant interface during the exam; and providing a rater interface that provides the response data for the exam and collects rating data for the response data for the exam, wherein the rater portal is configured to compute a rating for the exam using the rating data.

In some embodiments, the application services and domain services are implemented by at least one physical machine and at least one worker node, the physical machine providing a plurality of virtual machines corresponding to the plurality of application services, the worker node providing core compute resources and serve functions for the application services and the domain services.

In some embodiments, operations involve providing an auto-scaling cluster with a control plane network for an auto-scaling controller node group and a data plane network for an auto-scaling worker node group, the control plane network being a set of services running on nodes that communicate with worker nodes of the auto-scaling worker node group, the data plane network providing communication between the services and implementing functionality of the services, wherein the auto-scaling cluster scales nodes of the groups in response to requests by the application services and the domain services, wherein the worker nodes of the worker node group provide core compute resources and serve functions of the services.

In some embodiments, operations involve providing an authentication service that authenticates the applicant prior to providing the exam to the applicant interface.

In some embodiments, test is a constructed-response test, wherein the response data comprises audiovisual constructed-response data and wherein the applicant portal is configured to collect the audiovisual constructed-response data.

In some embodiments, operations involve providing the audiovisual constructed-response data at the rater interface.

In some embodiments, the exam comprises a plurality of scenarios, wherein a first set of response data relates to a first set of scenarios, and a second set of response data relates to a second set of scenarios, wherein the rater portal provides the rater interface with the first set of response data and collects rating data for the first set of response data, wherein the rating service automatically generates the second set of response data using a natural language processing service, wherein the rating service generates a hybrid rating for the applicant using the first set of response data and the second set of response data.

In some embodiments, the rating service uses a natural language processing service to automatically generate rating data for at least a portion of the response data for the exam.

In some embodiments, the proctor service uses a face detection service and/or voice detection service to monitor the exam at the applicant portal.

In some embodiments, the exam involves multiple scenarios, each scenario associated with one or more aspects, each scenario having one or more questions for testing the one or more aspects, each of the one or more questions having one or more corresponding response items of the response data, wherein the rating service generates rating data for a scenario by combining rating data for the corresponding response items to the one or more questions of the respective scenario.

In some embodiments, the exam service defines parameters for exam length required to meet test reliability standards.

In some embodiments, the exam involves at least one scenario having one or more questions and one or more corresponding response items, wherein the exam service converts the one or more questions into a question representation format and the one or more corresponding response items into a response representation format for the audiovisual response scenarios to minimize group differences.

In some embodiments, the rating service computes group difference measurements for the exam by processing the rating data and applicant data, wherein the rating service can define different group difference ranges to indicate negligible, small, moderate and large group differences.

In some embodiments, the exam service provides the audiovisual response scenarios by converting a response format to a constructed audiovisual response format.

In some embodiments, the exam service is configured to compile the exam using exam portal to receive selected scenario and question items for the exam and compile the selected scenario and question items into the exam.

In some embodiments, the proctor service and the proctor portal provide an test support interface to provide test support for applicant portal.

In another aspect, there is provided non-transitory computer readable memory having recorded thereon statements and instructions for execution by a hardware processor to carry out operations for online testing comprising: providing an interface for an online test comprising audiovisual response scenarios, each audiovisual response scenario having one or more corresponding questions, wherein the interface is configured to receive audiovisual response data for the questions; and collecting the audiovisual response data at the interface from an applicant electronic device having one or more input devices configured to capture and transmit the audiovisual response data.

In some embodiments, the test is a constructed-response test, wherein the audiovisual response data is audiovisual constructed-response data.

In some embodiments, operations involve providing the collected audiovisual response data and collecting rating data corresponding to the audiovisual response data.

In some embodiments, operations involve automatically generating at least a portion rating data for the response data using a natural language processing service.

In some embodiments, the exam comprises a plurality of scenarios, wherein a first set of response data relates to a first set of scenarios, and a second set of response data relates to a second set of scenarios, wherein a rater portal provides a rater interface with the first set of response data and collects rating data for the first set of response data, wherein the rating service automatically generates the second set of response data using a natural language processing service, wherein the rating service generates a hybrid rating for the test using the first set of response data and the second set of response data.

In some embodiments, operations involve monitoring the test using a face detection service and/or voice detection service.

In some embodiments, the online test involves multiple scenarios, each scenario associated with one or more aspects, each scenario having one or more questions for testing the one or more aspects, each of the one or more questions having one or more corresponding response items of the response data, wherein the rating service generates rating data for a scenario by combining rating data for the corresponding response items to the one or more questions of the respective scenario.

In some embodiments, operations involve defining parameters for exam length required to meet test reliability standards.

In some embodiments, wherein the test involves at least one scenario having one or more questions and one or more corresponding response items, wherein the exam service converts the one or more questions into a question representation format and the one or more corresponding response items into a response representation format for the audiovisual response scenarios to minimize group differences.

In some embodiments, operations involve computing group difference measurements for the online test by processing rating data for the responses and applicant data, wherein the processor can define different group difference ranges to indicate negligible, small, moderate and large group differences.

In some embodiments, operations involve providing the audiovisual response scenarios by converting a response format to a constructed audiovisual response format.

In some embodiments, operations involve generating the online test by receiving selected scenarios and question items and compiling the selected scenario and question items for the test.

In some embodiments, operations involve providing an test support interface to provide test support for applicant electronic device.

In another aspect, there is provided non-transitory computer readable memory having recorded thereon statements and instructions for execution by a hardware processor to carry out operations for online testing comprising: providing an interface for an online test comprising scenarios and questions, wherein the interface is configured to receive response data; collecting the audiovisual response data from an applicant electronic device configured to capture the audiovisual response data and transmit the response data to the interface; and providing a rating service to automatically generate rating data for the response data using a natural language processing service.

In some embodiments, operations involve collecting human rating data for the response data, and computing hybrid rating data using the automatically generated rating data and the human rating data.

In some embodiments, operations involve collecting human rating data for the response data, and correlating machine predicted ratings with the human rating data to evaluate reliability of the rating data or the human rating data.

In some embodiments, a response item has corresponding rating data comprising both human rating data and machine predicted rating data to evaluate reliability of the rating data.

In some embodiments, a first response item has corresponding human rating data and a second response item has corresponding machine predicted rating data to automate generation of at least a portion of the rating data.

In another aspect, there is provided a computer system for online testing, the system comprising: a plurality of client web applications comprising an applicant portal, an administrator portal, a proctor portal, and a rater portal; a plurality of application services comprising an exam application programming interface service, a content application programming interface service, a proctor application programming interface service, a rating application programming interface service, an administrator application programming interface service, and account application programming interface service; an application programming interface gateway to transmit messages and exchange data between the plurality of client web applications and the plurality of application services; a plurality of domain services comprising an exam service, a content service, a proctor service, a rating service, an administrator service, and account service; a message queue service for coordinating messages between the plurality of application services and the plurality of domain services; wherein the applicant portal is configured to provide an applicant interface to provide an exam for an applicant and collect response data for the exam, wherein the exam service and the exam application programming interface service compile the exam for the applicant, the exam comprising a test of a collection of scenarios, wherein the content application programming interface service and the content service delivers content for the exam, wherein the applicant portal is configured to provide the content for the exam at the applicant interface; wherein the proctor portal is configured to provide a proctor interface that monitors the applicant portal during the exam; and wherein rater portal is configured to provide a rater interface that provides the response data for the exam and collects rating data for the response data for the exam, wherein the rater portal is configured to compute a rating for the exam using the rating data.

In some embodiments, the application services and domain services are implemented by at least one physical machine and at least one worker node, the physical machine providing a plurality of virtual machines corresponding to the plurality of application services, the worker node providing core compute resources and serve functions for the application services and the domain services.

In some embodiments, the system has an auto-scaling cluster with a control plane network for an auto-scaling controller node group and a data plane network for an auto-scaling worker node group, the control plane network being a set of services running on nodes that communicate with worker nodes of the auto-scaling worker node group, the data plane network providing communication between the services and implementing functionality of the services, wherein the auto-scaling cluster scales nodes of the groups in response to requests by the application services and the domain services, wherein the worker nodes of the worker node group provide core compute resources and serve functions of the services.

In some embodiments, the system has an authentication service, wherein the applicant portal authenticates the applicant using the authentication service prior to providing the exam to the applicant interface.

In some embodiments, the test is a constructed-response test, wherein the response data comprises audiovisual constructed-response data and wherein the applicant portal is configured to collect the audiovisual constructed-response data.

In some embodiments, the rater portal is configured to provide the audiovisual constructed-response data at the rater interface.

In some embodiments, the exam comprises a plurality of scenarios, wherein a first set of response data relates to a first set of scenarios, and a second set of response data relates to a second set of scenarios, wherein the rater portal provides the rater interface with the first set of response data and collects rating data for the first set of response data, wherein the rating service automatically generates the second set of response data using a natural language processing service, wherein the rating service generates a hybrid rating for the applicant using the first set of response data and the second set of response data.

In some embodiments, the rating service uses a natural language processing service to automatically generate rating data for at least a portion of the response data for the exam.

In some embodiments, the proctor service uses a face detection service and/or voice detection service to monitor the exam at the applicant portal.

In some embodiments, the exam involves multiple scenarios, each scenario associated with one or more aspects, each scenario having one or more questions for testing the one or more aspects, each of the one or more questions having one or more corresponding response items of the response data, wherein the rating service generates rating data for a scenario by combining rating data for the corresponding response items to the one or more questions of the respective scenario.

In some embodiments, the exam service defines parameters for exam length required to meet test reliability standards.

In some embodiments, the exam involves at least one scenario having one or more questions and one or more corresponding response items, wherein the exam service converts the one or more questions into a question representation format and the one or more corresponding response items into a response representation format for the audiovisual response scenarios to minimize group differences.

In some embodiments, the rating service computes group difference measurements for the exam by processing the rating data and applicant data, wherein the rating service can define different group difference ranges to indicate negligible, small, moderate and large group differences.

In some embodiments, the exam service provides the audiovisual response scenarios by converting a response format to a constructed audiovisual response format.

In some embodiments, the exam service is configured to compile the exam using exam portal to receive selected scenario and question items for the exam and compile the selected scenario and question items into the exam.

In some embodiments, the proctor service and the proctor portal provide an test support interface to provide test support for applicant portal.

In accordance with an aspect, there is provided a computer method for online testing. The method involves a system having: a plurality of client web applications comprising an applicant portal, an administrator portal, a proctor portal, and a rater portal; a plurality of application services comprising an exam application programming interface (API) service, a content API service, a proctor API service, a rating API service, an administrator API service, and account API service; a plurality of domain services comprising an exam service, a content service, a proctor service, a rating service, an administrator service, and account service; an API gateway to transmit messages from the plurality of client web applications to the plurality of application services; a message queue service for coordinating messages between the plurality of application services and the plurality of domain services. The applicant portal provides an exam for an applicant and collects response data for the exam, wherein the exam is provided using the exam API service and the exam service, wherein content for the exam is provided by the content API service and the content service. The proctor portal monitors the applicant during the exam. The rater portal provides the response data for the exam and collects rating data for the response data for the exam.

In some embodiments, the method uses an authentication service, wherein the applicant portal authenticates the applicant using the authentication service prior to providing the exam.

In some embodiments, the response data comprises audiovisual response data and wherein the applicant portal is configured to collect the audiovisual response data.

In some embodiments, the exam comprises a plurality of scenarios, wherein a first set of response data relates to a first set of scenarios, and a second set of response data relates to a second set of scenarios, wherein the rater portal provides the first set of response data and collects rating data for the first set of response data, wherein the rating service automatically generates the second set of response data using a natural language processing service, wherein the rating service generates a hybrid rating for the applicant using the first set of response data and the second set of response data.

In some embodiments, the test is a constructed response test.

In accordance with an aspect, there is provided a computer system for online testing. The system has: a memory; a processor coupled to the memory programmed with executable instructions, the instructions including an interface for an online test comprising scenarios and questions, wherein the interface is configured to receive audiovisual response data; and an applicant electronic device having one or more input devices configured to collect the audiovisual response data and having a transmitter for transmitting the collected audiovisual response data to the interface.

In some embodiments, the test is a constructed-response test, wherein the audiovisual response data is audiovisual constructed-response data.

In some embodiments, the system has a rater electronic device for collecting rating data for the response data.

In some embodiments, the system has a rating service to automatically generate rating data for the response data. In some embodiments, the rating service communicates with a natural language processing service to automatically generate the rating data.

In accordance with an aspect, there is provided a computer system for online testing. The system has: a memory; a processor coupled to the memory programmed with executable instructions, the instructions including an interface for an online test comprising scenarios and questions, wherein the interface is configured to receive response data; an applicant electronic device having one or more input devices configured to collect the audiovisual response data and having a transmitter for transmitting the collected response data to the interface; and a physical machine configured with a rating service to automatically generate rating data for the response data using a natural language processing service.

In some embodiments, the system has a rater electronic device for collecting human rating data for the response data, wherein the rating service computes hybrid rating data using the automatically generated rating data and the human rating data.

Many further features and combinations thereof concerning embodiments described herein will appear to those skilled in the art following a reading of the instant disclosure.

### DESCRIPTION OF THE FIGURES

In the figures,

FIG. 1 shows an example architecture diagram of a system for secure online testing.

FIG. 2 shows an example schematic diagram of worker nodes for a system for secure online testing.

FIG. 3A shows an example schematic diagram of services for a system for secure online testing.

FIG. 3B shows an example schematic diagram of an auto-scaling cluster for a system for secure online testing.

FIG. 3C shows an example schematic diagram of a production cluster for a system for secure online testing.

FIG. 4 is a diagram of an example method for online testing.

FIG. 5 is a diagram of an example method for rater training.

FIG. 6 is an example process for test item creation and review.

FIG. 7 is a diagram of an example process flow for test compilation and review.

FIG. 8 is a diagram of an example process flow for test compilation and test construction.

FIG. 9 is a schematic diagram of example in-test support.

FIG. 10 is a diagram of an example system that connects to different electronic devices.

FIG. 11 is a diagram illustrating horizontal scalability of an example system for online testing.

FIG. 12 shows example domain services.

FIG. 13 shows an example stateless service.

FIG. 14 shows an example stateless service.

FIG. 15 shows an example stateful service.

FIG. 16 is a diagram of an example system for generating commands.

FIG. 17 is a diagram of an example system for processing commands.

FIG. 18 is a diagram of an example command and query flow.

FIG. 19 is a graph relating to auto-scoring scenarios.

FIG. 20 is a graph relating to auto-scoring scenarios.

FIG. 21 is a graph relating to hybrid scoring scenarios.

FIG. 22 is a graph relating to hybrid scoring scenarios.

FIG. 23 shows an example template of designs for building tests or exams.

FIG. 24 is a diagram for exam composability for different types of tests or exams.

FIG. 25 is a diagram of example set up activities.

FIG. 26 is a diagram of example practice activities.

FIG. 27 is a diagram of example test activities.

FIG. 28 is a diagram of example survey activities.

### DETAILED DESCRIPTION

Embodiments described herein relate to systems and methods for secure online testing with minimal group differences. Embodiments described herein involve the conversion of an onsite test environment to an online distributed computer platform. The online platform can have sufficient malleability to accommodate conversion to the computer hardware environment. Embodiments described herein provide a modular online test platform.

Embodiments described herein involve conversion of authentication or monitoring procedures for online testing. For example, embodiments described herein may involve the use of voice recognition and/or facial recognition software to authenticate and monitor test takers, which may be referred to as applicants or examinees.

Embodiments described herein relate to systems and methods for constructed-response tests that can involve different types of assessments to measure non-cognitive skills (including but not limited to professionalism, situational awareness, and social intelligence) using constructive open responses. Another example test to measure non-cognitive skills is a situational judgement tests (SJT), or similar tests that measure various non-cognitive skills based on examinees' actions for hypothetical real-life scenarios.

A constructed-response test can involve video-based or written scenarios. A constructed-response test has corresponding constructed-response items. Examinees can either watch a video or read a scenario and then respond to a set of constructed-response items associated with the scenario. In each scenario, multiple aspects of professionalism can be measured. Embodiments described herein relate to computerized, online test designed for assessing different aspects of professionalism such as collaboration, communication, equity, ethics, empathy, motivation, problem-solving, self-awareness, and resilience. An example test is a constructed-response test.

A test can involve multiple scenarios. Each scenario can be associated with one or more professionalism aspects (e.g. communication, empathy, equity, and ethics). Each scenario can be associated with one or more questions, and corresponding response items for the questions. A scoring or rating can be generated by combining scores or ratings for responses to questions relating to each scenario. As an example, responses to questions for each scenario can be assigned a rating or score between 1 (lowest) and 9 (highest).

Embodiments described herein can relate to constructed-response (or open-ended response) testing configured for audiovisual responses to reduce group differences compared to written responses and selected (e.g. fixed) responses. Embodiments described herein related to constructed-response testing, such as situational judgment testing (SJT) for example, using minimal item stem text and audiovisual constructed-responses to minimize group differences. The responses can be scored using video and audio data for audiovisual response or by generating its auto-transcript. Tests can also be referred to as exams.

Differential access to educational and/or environmental opportunities can contribute to differences in reading and/or writing skills that may be required for text-based response formats of cognitive tests. Using constructed-response format over selected response format also has beneficial implications for test length. Further, why test takers choose responses may be more important than what responses test takers choose in ethical decision-making. Test-takers' explanation of their thought processes may be more differentiating (and hence more effective for test reliability) than their selected answer. Embodiments described herein can define parameters for test length required to meet standards of test reliability (e.g. Cronbach's Alpha R>0.80). Improved scoring rubrics for parallel use with written constructed responses may be used to determine whether test length can be further reduced (e.g. below 8 items) while maintaining standards of test reliability (e.g. R>0.80). Predictive validity for future performance may not be negatively impacted upon with test item length is further reduced (e.g. to 7 items).

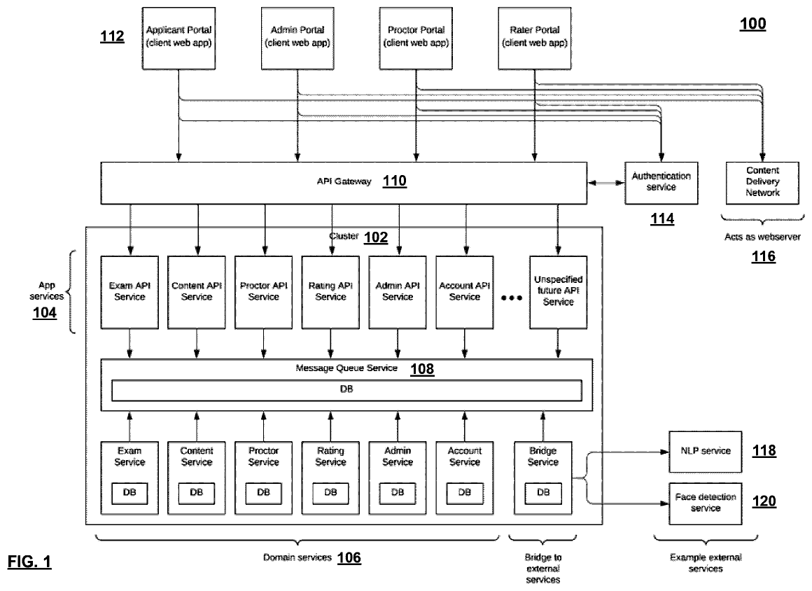

FIG. 1 shows an example architecture diagram of a system 100 for secure online testing. System 100 provides a modular online test platform.

System 100 has a cluster 102 of application services 104 and domain services 106 in communication via a message queue service 108. System 100 can have an API gateway 110 for communication between different client web applications 112 and the application services 104. System 100 can also have an authentication service 114 to authenticate users' client web applications 112 and their respective electronic devices. System 100 also has a content delivery service 116 to deliver test content to client web applications 112 and electronic devices.

Architecture of system 100 has domain services that implement functions for online testing, and the application services 104 receives commands from client web applications 112 and exchange data in response to requests. Message queue service 108 coordinates messages between application services 104 and domain services 106. Message queue 108 ensures delivery of messages to the relevant service even if offline.

Application services 104 can include a number of different service APIs. Example API services include: exam API service, content API service, proctor API service, rating API service, administration API service, account API service. There can be additional application services 104 added to the cluster 102 to provide different functionality for system 100.

Domain services 106 can include a number of different services corresponding to application services 104. Example domain services 106 include: exam service, content service, proctor service, rating service, administration service, account service. There can be additional services added to the cluster 102 to provide different functionality for system 100. Exam service delivers online tests or exams to users, and scales based on number of users. Content service allows for content creation and management. When an exam is running then content services delivers content for the exam.

Message queue service 108 coordinates communication between application services 104 and domain services 106. Instead of having the application services 104 and domain services 106 communicate directly to each other, each of the application services 104 and domain services 106 communications with the message queue 108 which coordinates messaging between the application services 104 and domain services 106. This enables the application services 104 and domain services 106 to perform functions without having to understand the details (e.g. protocols, configurations, commands) of all the other services. Additional application services 104 and domain services 106 can be added on as new services to plug into the message queue 108.

Client web applications 112 include different types of interfaces or portals for different users. For example, client web applications 112 can include: applicant portal, administrator portal, proctor portal, rater portal. Client web applications 112 provide an interface layer to provide front-end user interfaces. Client web applications 112 interact with the different application services 104 via API gateway 102 to exchange data and commands.

System 100 has a bridge service 122 to connect to different external services. For example, system 100 can use bridge service 122 to connect with natural language processing (NLP) service 118 to provide different NLP functions as described herein. System 100 can also connect to a face detection service 120 to provide detection and monitoring services for online testing as described herein. In other embodiments, NLP service 118 and face detection service 120 can be internal domain services 106. Face detection service 120 can recognize faces in the images and responses with the output data. Face detection service 120 does not respond based on the other images or requests. Accordingly, it can be considered stateless.

Domain service 106 can include exam service and content service. Exam service compiles exams for applicants. An exam may have different parts such as set up, practice, test, and survey. Within the test there can be a collection of scenarios. A subset of scenarios may be typed response scenarios and another subset of scenarios may be audiovisual response (AVR) scenarios. Content service would serve the AVR content for the exam. Accordingly, for AVR, the content service can work with the exam service to provide AVR content for exams. The web applications 112 would also have plugins for AVR so that AVR content can be provided. Content delivery network 116 can also be used to implement aspects of AVR content delivery.

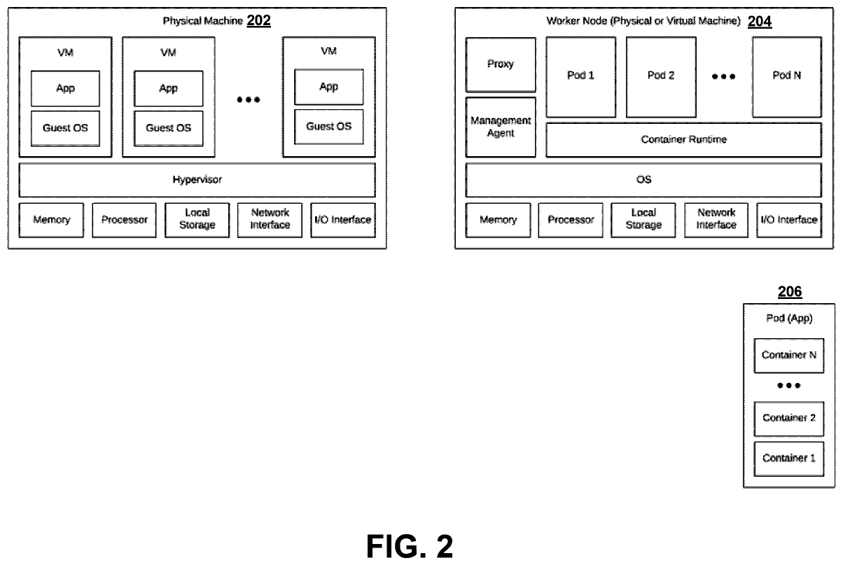

FIG. 2 shows an example schematic diagram of a worker node 204 for a system 100 for secure online testing. System 100 for secure online testing (or components thereof) can be implemented by one or more physical machines 202 and one or more worker nodes 204. Physical machine 202 can have at least one processor, memory, local storage device, network interface, and I/O interface.

Each processor may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Memory may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Each I/O interface enables physical machine 202 to interconnect with one or more input devices, such as a keyboard, mouse, camera, touch screen and a microphone, or with one or more output devices such as a display screen and a speaker. Each network interface enables physical machine 202 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Physical machines 202 is operable to register and authenticate users (using a login, unique identifier, and password for example) prior to providing access to applications, a local network, network resources, other networks and network security devices. Physical machine 202 may serve one user or multiple users.

Physical machine 202 has virtual machines with applications and guest operating systems. Worker node 204 can be a physical or virtual machine. For example, worker node 204 can be running in a cloud system or on one or more physical machines. Worker node 204 provides the core set of compute resources to run different applications for online testing, such as the application services and the domain services. Worker node 204 has a number of Pods (Pod1, Pod2, . . . . PodN). Pod is like an application or collection of containers (e.g. code) designed to run on the same machine. The number of worker nodes 204 scale depending on the service demands.

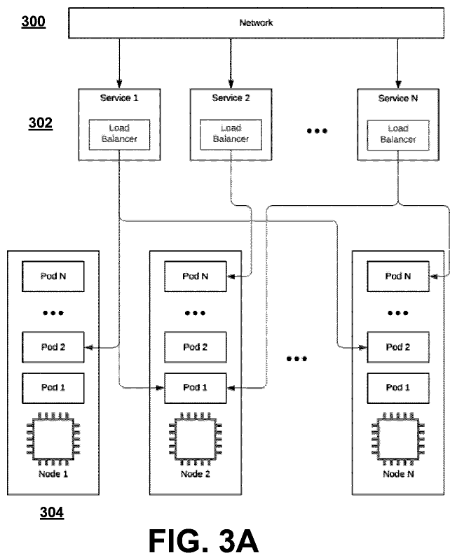

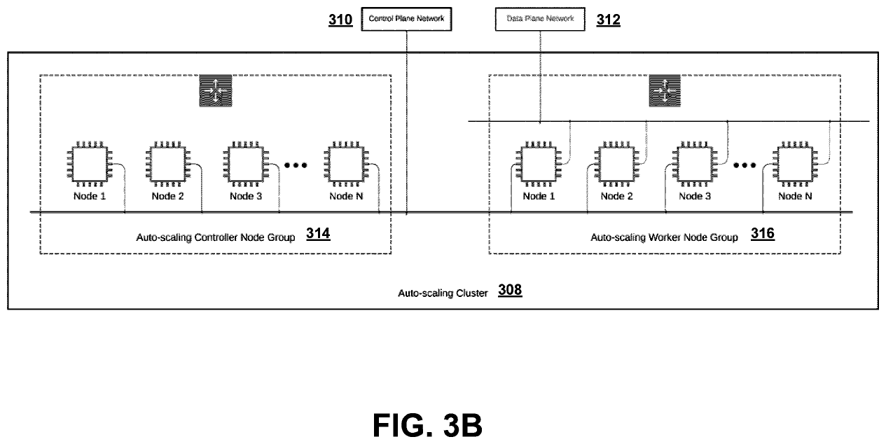

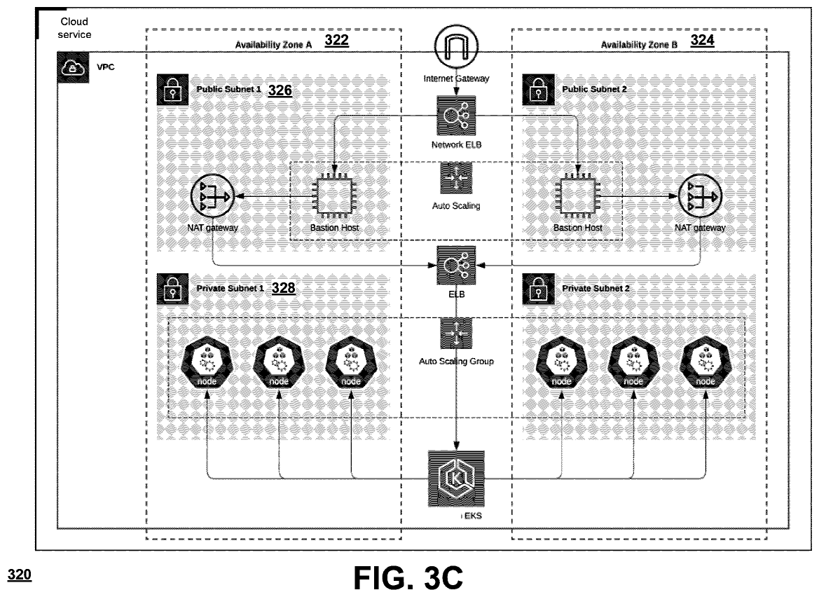

FIG. 3A shows an example schematic diagram of services 302 for a system 100 for secure online testing. Network 300 connects to services 302 which in turn connected to different nodes 304 and sets of Pods. A service 302 is built on Pods that are running on multiple nodes 304. This provides fault tolerance because there are multiple instances of the online testing application running on different nodes 304 with pods. Services 302 route to different pods and nodes 304. This provides a flexible and scalable system of hardware components with auto-scaling clusters.

FIG. 3B shows an example schematic diagram of an auto-scaling cluster 308 for a system 100 for secure online testing. Auto-scaling cluster 308 manages the scaling of components of the system 100. Auto-scaling cluster 308 has two parts: control plane network 310 and data plane network 312. Auto-scaling cluster 308 has auto-scaling controller node groups 314 of multiple nodes (Node 1, Node 2, Node 3, Node N) and auto-scaling worker node groups 314 of multiple nodes (Node 1, Node 2, Node 3, . . . . Node N). Controllers add nodes dynamically as additional capacity is needed. Control plane network 310 is a set of services running on nodes that communicate with worker nodes (that are working to serve the application functions). Data plane network 314 is where the main applications communicate and where the main functions are implemented.

FIG. 3C shows an example schematic diagram of a production cluster 320 for a system 100 for secure online testing. Production cluster 320 has availability zone A 322 and availability zone B 324 that are physically different data centres on different hardware infrastructure to provide redundancy. If there is a fault with one zone then the availability zones 322, 324 are mirrored so the system 100 can continue running on the other zone.

Production cluster 320 has public subnets 326 (Public Subnet 1, Public Subnet 2 . . . ) and private subnets 328 (Private Subnet 1, Private Subnet 2 . . . ). Public subnet 326 can be considered a DMZ which is a gateway from a public network into the system 100. All traffic comes into system 100 via gateway and an elastic load balancer (ELB) to balance load across system resources by splitting the traffic to spread out traffic over a large number of recipients. Public subnet 326 has Bastion Host (e.g. server, VM, container) that runs NAT gateway to forward traffic into private subnet 328. Bastion Hosts of public subnets 326 can scale automatically using auto-scaling. Controller scales the Bastion Hosts in response to traffic demand. There is a layer of security for private subnets 328 as there is no way to access the nodes within the private subnet 328 except via the secure gateways. Private subnet 328 has multiple nodes that can scale automatically using auto-scaling group. Controller determines resources needed and auto scales the nodes as needed.

Accordingly, system 100 provides different client web applications 112 such as an applicant portal, an administrator portal, a proctor portal, and a rater portal. System 100 provides different application services 104 such as an exam API service, a content API service, a proctor API service, a rating API service, an administrator API service, and account API service. System 100 provides an API gateway to transmit messages and exchange data between the client web applications 112 and the application services 104. System 100 provides different domain services 106 such as an exam service, a content service, a proctor service, a rating service, an administrator service, and account service. System 100 provides a message queue service 108 for coordinating messages between the application services 104 and the domain services 102.

The applicant portal is configured to provide an applicant interface to provide an exam for an applicant and collect response data for the exam. The exam service and the exam application programming interface service compile the exam for the applicant. The exam includes a test of a collection of scenarios with at least a subset of scenarios being audiovisual response scenarios. The content API service and the content service delivers content for the exam, including audiovisual content. The applicant portal is configured to provide the audiovisual content at the applicant interface. The proctor portal is configured to provide a proctor interface that monitors the applicant portal during the exam. The rater portal is configured to provide a rater interface that provides the response data for the exam and collects rating data for the response data for the exam. The rater portal is configured to compute a rating for the exam using the rating data.

In some embodiments, the application services and domain services are implemented by at least one physical machine 202 and at least one worker node 204. The physical machine 202 provides a plurality of virtual machines corresponding to the application services 102 and domain services 104. The worker node 204 provides core compute resources and serve functions for the application services 102 and the domain services 104.

In some embodiments, the system 100 has an auto-scaling cluster 308 with a control plane network 310 for an auto-scaling controller node group 314 and a data plane network 312 for an auto-scaling worker node group 316. The control plane network 310 is a set of services running on nodes that communicate with worker nodes of the auto-scaling worker node group 316. The data plane network 312 provides communication between the services and implements functionality of the services. The auto-scaling cluster 308 scales nodes of the groups in response to requests by the application services 102 and the domain services 104. The worker nodes of the worker node group 316 provide core compute resources and serve functions of the services.

In some embodiments, the system 100 has an authentication service 114. The applicant portal authenticates the applicant using the authentication service 114 prior to providing the exam to the applicant interface.

In some embodiments, the test is a constructed-response test. The response data comprises audiovisual constructed-response data and the applicant portal is configured to collect the audiovisual constructed-response data. In some embodiments, the rater portal is configured to provide the audiovisual constructed-response data at the rater interface.

In some embodiments, the exam comprises a plurality of scenarios. A first set of response data relates to a first set of scenarios, and a second set of response data relates to a second set of scenarios. The rater portal provides the rater interface with the first set of response data and collects rating data for the first set of response data. The rating service automatically generates the second set of response data using a natural language processing service. The rating service generates a hybrid rating for the applicant using the first set of response data and the second set of response data.

In some embodiments, the rating service uses a natural language processing service to automatically generate rating data for at least a portion of the response data for the exam.

In some embodiments, the proctor service uses a face detection service and/or voice detection service to monitor the exam at the applicant portal.

In some embodiments, the exam involves multiple scenarios, each scenario associated with one or more aspects. Each scenario has one or more questions for testing the one or more aspects, each of the one or more questions having one or more corresponding response items of the response data. The rating service generates rating data for a scenario by combining rating data for the corresponding response items to the one or more questions of the respective scenario.

In some embodiments, the exam service defines parameters for exam length required to meet test reliability standards.

In some embodiments, the exam involves at least one scenario having one or more questions and one or more corresponding response items. The exam service converts the one or more questions into a question representation format and the one or more corresponding response items into a response representation format for the audiovisual response scenarios to minimize group differences.

In some embodiments, the rating service computes group difference measurements for the exam by processing the rating data and applicant data. The rating service can define different group difference ranges to indicate negligible, small, moderate and large group differences.

In some embodiments, the exam service provides the audiovisual response scenarios by converting a response format to a constructed audiovisual response format.

In some embodiments, the exam service is configured to compile the exam using exam portal to receive selected scenario and question items for the exam and compile the selected scenario and question items into the exam.

In some embodiments, the proctor service and the proctor portal provide an test support interface to provide test support for applicant portal.

In some embodiments, system 100 has an interface for an online test comprising audiovisual response scenarios, each audiovisual response scenario having one or more corresponding questions. The interface is configured to receive audiovisual response data for the questions. The system 100 connects to an applicant electronic device having one or more input devices configured to collect the audiovisual response data and having a transmitter for transmitting the collected audiovisual response data to the interface. In some embodiments, the test is a constructed-response test, wherein the audiovisual response data is audiovisual constructed-response data. In some embodiments, system 100 has a rater electronic device for providing the collected audiovisual response data and collecting rating data corresponding to the audiovisual response data. In some embodiments, system 100 has a rating service to automatically generate at least a portion rating data for the response data. In some embodiments, the rating service communicates with a natural language processing service to automatically generate at least a portion of the rating data.

In some embodiments, the exam comprises a plurality of scenarios, wherein a first set of response data relates to a first set of scenarios, and a second set of response data relates to a second set of scenarios. A rater portal provides a rater interface with the first set of response data and collects rating data for the first set of response data. The rating service automatically generates the second set of response data using a natural language processing service. The rating service generates a hybrid rating for the test using the first set of response data and the second set of response data.

In some embodiments, the proctor service monitors the test using a face detection service and/or voice detection service to monitor the applicant electronic device.

In some embodiments, the online test involves multiple scenarios, each scenario associated with one or more aspects, each scenario having one or more questions for testing the one or more aspects, each of the one or more questions having one or more corresponding response items of the response data. The rating service generates rating data for a scenario by combining rating data for the corresponding response items to the one or more questions of the respective scenario.

In some embodiments, system 100 defines parameters for exam length required to meet test reliability standards.

In some embodiments, the test involves at least one scenario having one or more questions and one or more corresponding response items. The exam service converts the one or more questions into a question representation format and the one or more corresponding response items into a response representation format for the audiovisual response scenarios to minimize group differences.

In some embodiments, system 100 computes group difference measurements for the online test by processing rating data for the responses and applicant data, wherein the processor can define different group difference ranges to indicate negligible, small, moderate and large group differences.

In some embodiments, system 100 provides the audiovisual response scenarios by converting a response format to a constructed audiovisual response format. In some embodiments, system 100 generates the online test by receiving selected scenarios and question items and compiling the selected scenario and question items for the test.

In some embodiments, system 100 provides an test support interface to provide test support for applicant electronic device.

In another aspect, system 100 provides an interface for an online test comprising scenarios and questions. The interface is configured to receive response data. System 100 connects to an applicant electronic device having one or more input devices configured to collect the audiovisual response data and having a transmitter for transmitting the collected response data to the interface. System 100 has a physical machine configured with a rating service to automatically generate rating data for the response data using a natural language processing service.

In some embodiments, system 100 has a rater electronic device for collecting human rating data for the response data, wherein the rating service computes hybrid rating data using the automatically generated rating data and the human rating data. In some embodiments, system 100 has a rater electronic device for collecting human rating data for the response data, wherein the rating service correlates machine predicted ratings with the human rating data to evaluate reliability of the rating data or the human rating data. In some embodiments, a response item has corresponding rating data comprising both human rating data and machine predicted rating data to evaluate reliability of the rating data. In some embodiments, a first response item has corresponding human rating data and a second response item has corresponding machine predicted rating data to automate generation of at least a portion of the rating data.

Embodiments described herein relate to converting onsite testing to secure online testing and for providing an online test platform. Embodiments described herein relate to converting sub-optimally secure online testing to optimally secure online testing. Embodiments described herein relate to a distributed computer hardware environment to support secure, resource-efficient online testing.

The process of converting onsite and online testing to optimally secure, resource-efficient online testing with minimal group differences may require conversion of different components, such as, for example: (1) test equipment site and infrastructure, (2) question representation format, (3) response format, (4) scoring methodology, and (5) authentication and monitoring procedures.

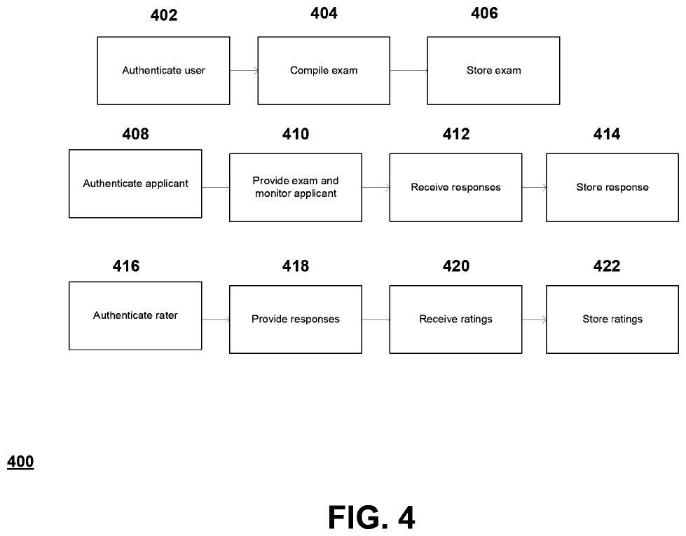

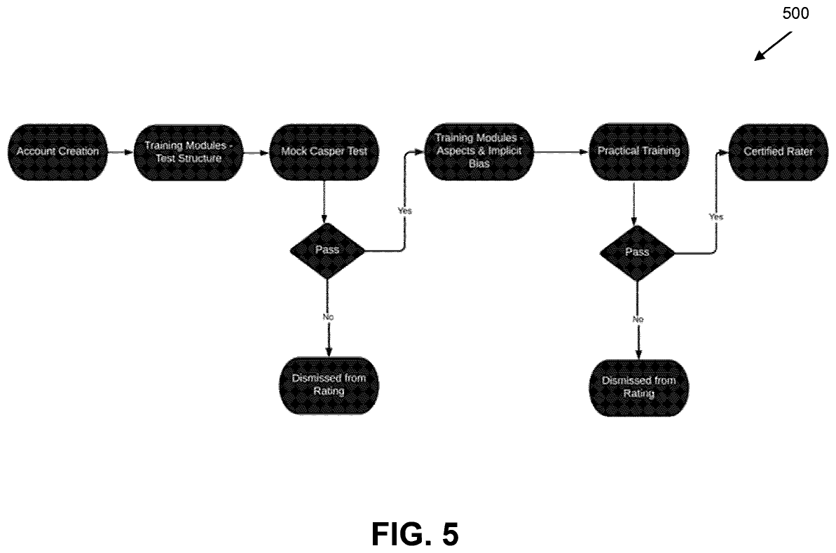

FIG. 4 is a diagram of a process 400 for online testing. At 402, system 100 authenticates a user that will create or generate the exam. At 404, system 100 compiles the exam with content and, at 406, stores the exam in memory. At 408, system 100 authenticates an applicant or examinee, and, at 401, provides the exam at the applicant portal. System 100 can monitor the applicant at the applicant portal for the duration of the exam. At 412, system 100 receives response data for the exam and stores the response data in memory. At 416, system 100 authenticates a rater at the rater portal and, at 418, provides the response data. At 420, system 100 receives rating data and, at 422, stores the rating data in memory. System 100 can also automatically generate rating data for the response data. System 100 can generate hybrid rating data by combining human response data and automatically generated rating data. The process 400 can involve other operations as described herein.

Embodiments described herein provide for secure, resource efficient online testing that considers a set of components which may augment goals of optimal access, resource allocation, overall cost, test length, group differences, test security, and so on. This set of components includes but is not limited to speeded testing; shifting from measuring achievement to measuring ability; scoring rubrics; rater training; group differences monitoring; item creation and review; test construct determination; parallel test form creation; natural language processing for automated response review; and validity analyses including but limited to correlational analyses, factor and related analyses, and item response analyses.

Embodiments described herein may provide test parameter improvements. For example, embodiments described herein can provide improvement of test parameters along one or more of the axes of: resource allocation, test length, access, overall cost, test security, and group differences, monitoring, test construct determination, item creation and review, test compilation and review, parallel test form creation, in-test applicant support, quality assurance of test reliability including natural language processing (NLP) and human rater checks, and validity analyses including but limited to correlational analyses, factor and related analyses, and item response analyses.

The following are example test parameter outcomes that can be improved using various components of embodiments described herein: conversion of test site can optimize access, resource allocation and overall cost; conversion of question representation format and response format can minimize test length and group differences; conversion of scoring methodology can minimize test length and resource allocation; and conversion of authentication/monitoring procedures will optimize test security. These are example test parameter outcomes and embodiments described herein can also provide other improvements to test parameter outcomes.

System 100 can implement online test-taker authentication or monitoring using voice recognition of audio responses, or voice and facial recognition of audiovisual responses. System 100 can implement conversion of authentication and monitoring procedures for online testing. System 100 can use voice recognition and/or facial recognition software, for example.

System 100 converts onsite testing to a secure modular online test platform. The modular online test platform automatically scales compute resources in response to requests by applications and services.

System 100 converts question representation format and response format to minimize group differences. For example, if minimal item stem text and only pictographic selected response items are used for testing, then group differences can be reduced for cognitive testing. As another example, question item focus on ability rather than achievement, then group differences can be reduced for cognitive testing. As another example, for SJT, constructed (open-ended) AVRs can result in reduced group differences compared to constructed (open-ended) written responses, and compared to selected (fixed) responses. As a further example, SJT using minimal item stem text and audiovisual constructed response can result in minimal group differences compared to written text response. This reduction in group difference may result whether the responses are scored on the AVR or the auto-transcript of the AVR. Differential access to educational and/or environmental opportunities contribute to differences in reading and/or writing skills that can appear in text-based situational judgment tests. Minimizing item stem text may not by itself reduce group differences as long as the response format remains text based. System 100 can consider test length. Using constructed response format over selected response format also has implications for test length. For example, why test takers chose a response may be more important than what they chose as the response in ethical decision-making. Test-takers' explanation of their thought processes may be more differentiating (and hence more effective for test reliability) than their selected answer. There can be test length requirements to meet standards of test reliability (e.g. Cronbach's Alpha R>0.80). For example, system 100 can set threshold parameters for test length required for acceptable reliability, relative to response format. The requirements can be defined by number of (test) items and test time. Decreasing test length and test time may provide greater depth of response for the AVR format. For example, there may be 8 items with a 50 min test time for written/typed response, or 6 items with a 25 minute test time for AVR. System 100 can use scoring rubrics for parallel use with written constructed responses to determine whether that test length can be further reduced (e.g. below 8 items) while maintaining standards of test reliability (e.g. R>0.802). Predictive validity for future performance may not be negatively impacted upon when test item length is further reduced (e.g. to 7 items).

Group differences can be measured using different methods. For example, group differences can be defined using Cohen's D<0.20 standard deviation (SD) as negligible, 0.20-0.50 as small, 0.50-0.80 as moderate, and >0.80 SD as large. System 100 can automatically compute group differences by processing rating data, application data, and response data.

Embodiments described herein can provide online testing platform that converts response formats to audio format or audiovisual response format. For example, selected response formats can be replaced with constructed audio or audiovisual format, with or without complementary selected responses. Embodiments described herein can replace text-based item stems (or scenarios) for cognitive tests and response options with pictographic and/or visual formats. Stems or scenarios for cognitive tests provide background and context for the test questions.

The system 100 can provide an online constructed-response test that includes multiple sections with video stems and audiovisual responses (AVR). As an illustrative (non-limiting) example, one-minute audiovisual response time can be provided for each of the AVR questions. Responses can be scored by raters using scoring guidelines for one or both of the AVR and the auto-transcribed versions (AT) of the AVR. The ratings can indicate that AVR minimize group differences between test takers, as compared to typed (e.g. text-based) responses. The minimal group differences for the AVR may be due to removal of writing skills as a confounding cognitive construct. Group differences can reduce (or altogether disappear) when altering SJT response format from written to audiovisual. In societies with markedly differential educational opportunities, constructed-response tests (such as SJTs, for example) with AVR may markedly enhance equitability.

System 100 can focus on ability rather than achievement to minimize group differences and resources.

Embodiments described herein may involve conversion of scoring methodology. Scoring responses for constructed-response tests generally involves judgement by human raters which can create efficiency and consistency challenges. Other factors such as examinees' writing ability (or lack thereof) may also influence group differences. System 100 can implement improved scoring methodologies. System 100 can use natural language processing (NLP) service 118 to automatically produce scores of constructed responses instead human rater scores, or to validate or augment human rater scorers. The system 100 can use NLP service 118 as a replacement of human rater scoring, or to augment human rater scoring using NLP service 118 for quality assurance to predict scoring and compare to human rater scoring.

Embodiments described herein provide system 100 for secure online testing that is configured to automate scoring or rating of to score the tests. Embodiments described herein involve automated rating of tests using NLP service 118. Embodiments described herein involve converting audio/video responses into a format suitable for NLP service 118 automated scoring. Further embodiments described herein involve hybrid rating of tests using NLP service 118. Further details on hybrid rating methods and implementations are provided herein.

Accordingly, system 100 can leverage NLP service 118 for evaluating scores or ratings of constructed-responses from assessments or tests focusing on different aspects of professionalism or non-cognitive skills, or cognitive skills, or technical skills. Embodiments described herein may involve NLP service 118 to automatically produce scores to evaluate constructed responses for replacement of human rater scoring, or augmentation of human rater scoring with quality assurance and validation. For example, embodiments described herein provide for secure online testing using NLP service 118 for automated response review and quality assurance (QA) of test reliability using natural language processing to validate human ratings. Further details relating to NLP quality assurance of ratings for constructed-response tests is provided in U.S. Provisional Patent Application No. 63/392,310 the entire contents of which is hereby incorporated by reference.

System 100 can implement speeded testing. For example, speeded testing findings include disincentive of cheating attempts and reduction of group differences. The test length parameters can be used by system 100 to implement speeded testing.

System 100 can implement scoring rubrics. For large scale testing of constructed responses, global rating scales may be equally or more advantageous psychometric while simpler and more efficiently applied, as compared to checklists. AVR testing can also suggest improved test reliability with moderate rather than short length anchor descriptions. System 100 can codify test reliability standards relating to test items and test length. System 100 can generate test reliability informing data to validate test reliability standards. The following table compares example test characteristics for AVR tests, and provides data comparison for scoring rubric approaches to testing and AVR.

| Scoring | Rater | Group | | Normal | IIC | Cronbach | Rel if 5 | Rel if 6 | Rel if 8 |
|---|---|---|---|---|---|---|---|---|---|
| Rubrics | Feedback | Differences | IRR | Distribution | Rel | Alpha | section | section | section |
| Global | Preferred | 0 - Small | | Yes | 0.18 | 0.31 | | | |
| rating, min | | | | | | | | | |
| Global | Preferred | 0 - Small | 0.46 | Yes | 0.48 | 0.65 | 0.79 | 0.82 | 0.85 |
| rating, mod | | | | | | | | | |
| Checklist | Non-pref | 0 - Small | 0.44 | Yes | 0.43 | 0.60 | 0.75 | 0.79 | 0.82 |
| (Analytic) | | | | | | | | | |

where Min = minimally described anchors,
Mod = moderately described anchors,
IRR = inter-rater reliability,
IIC Rel = Inter-Item Correlation Reliability

System 100 can implement rater training. For example, system 100 can implement rater training annually by geography through online modules. The rater training ensures raters are informed of new changes that may be been introduced by new research or product releases, as well as strengthen their current testing knowledge. The training can cover test format, tooling, workflow and process, new releases, implicit bias training, examples of performance expectations, and a pass or fail practical portion to demonstrate knowledge of the content. Sections of training have associated quizzes which have assigned minimum thresholds our Raters need to achieve in order to continue as a Rater.

FIG. 5 is a diagram of an example method 500 for rater training.

System 100 can implement group differences monitoring for online testing and rating. System 100 can measure group differences by processing response and rating data. Group differences for testing can be assessed by system 100 by computing standardized mean difference scores (d) that can be interpreted such that difference score ranges (e.g. of 0.20-0.50, 0.50-0.80, and >0.80) correspond to small, moderate, and large effect sizes, respectively. Group differences for testing can be monitored across applicant demographics (e.g. gender, socioeconomic status, geographic location, ethnicity, language proficiency, disability status, age). System 100 can monitor AVR rating group differences and can determine that group differences may be much smaller than other response formats. System 100 can implement different methods to compute group difference measurements to monitor group differences for online testing.

System 100 can implement test construct determination. Test construct is the aspects or characteristics the test intends to measure. Construct definition for a particular test thus varies from test to test. As an example, refer to table below which provides example aspects for test construction. Each test can be constructed for the different aspects, and each aspect can be represented by a scenario of the test. The remaining scenarios can be selected randomly. An AVR test can test aspects for professionalism and social awareness, for example.

| | | | |
|---|---|---|---|
| 1. | Collaboration | 2. | Communication |
| | “Ability to function interdependently | | “Ability to effectively interact with the |
| | by balancing individual & mutual | | intent of understanding and being clearly |
| | goals and demonstrate an | | understood in different contexts.” |
| | openness to others' perspectives & | | Communicates clearly and |
| | input, all in service of reaching | | respectfully electronically |
| | consensus and achieving a larger | | Effectively conveys information |
| | mission.” | | Facilitates discussion |
| | Demonstrates safe | | Listens effectively |
| | handover of care | | Negotiates and manages conflicts |
| | Engages in multi- | | Understands non-verbal |
| | perspective conversations | | behaviour |
| | Establishes & maintains | | Provides feedback |
| | relationships with peers | | Provides clear and accurate |
| | Learns collaboratively | | explanations |
| | Negotiates shared | | Adjusts communication approach |
| | responsibilities and | | depending on situation |
| | decision-making | | |
| | Self-sacrificing in favour of | | |
| | team | | |
| | Shares knowledge readily | | |
| | Works towards shared | | |
| | goals humbly | | |
| | Works with community to | | |
| | determine issues | | |
| 3. | Empathy | 4. | Equity |
| | “Ability to take the perspective of | | “Ability to acknowledge, appreciate, and |
| | another person's feelings and | | respect the individual & cultural values, |
| | context in a given situation.” | | preferences, experiences, and needs of |
| | Assesses learners | | others.” |
| | respectfully | | Responds to individual patient |
| | Humbly recognizes | | circumstances |
| | uncertainty in professional | | Recognizes & addresses |
| | contexts | | communication barriers |
| | Sensitive to others' needs | | Respects diversity & individuality |
| | Supports colleagues in | | Knowledge of socio-cultural |
| | need | | factors |
| | Displays compassion and | | Recognizes & addresses |
| | care in interactions | | personal biases |
| | | | Appreciates & understands |
| | | | diversity |
| 5. | Ethics | 6. | Motivation |
| | “Ability to maintain a set of moral | | “Ability to reflexively, actively, and |
| | principles (namely respect for | | persistently apply oneself to achieving |
| | autonomy, goodwill, integrity, | | one's personal best.” |
| | honesty, and justice) that dictate | | Desire to continuously improve |
| | personal and professional | | Reflects on own learning and self |
| | behaviour.” | | Makes good use of feedback |
| | Encourages healthy and | | Improves personally |
| | moral behaviour | | Understands own skills & |
| | Fulfils codes of ethics | | limitations |
| | Demonstrates moral | | |
| | reasoning | | |
| | Cultivates integrity and | | |
| | honesty | | |
| | Identifies and adheres to | | |
| | ethical principles | | |
| | Remains honest and | | |
| | trustworthy | | |
| | Encourages trust | | |
| 7. | Problem Solving | 8. | Professionalism |
| | “Ability to recognize and define a | | “Ability to acknowledge one's |
| | problem, develop a process to | | responsibilities as a professional by |
| | tackle it, and evaluate the | | demonstrating and maintaining high |
| | approach for its efficacy.” | | personal standards of thoughtful, |
| | Seeks & synthesizes | | accountable, respectful, and regulated |
| | relevant information | | behaviour.” |
| | Demonstrates critical & | | Creates environments prioritizing |
| | evidence-based reasoning | | safety, comfort, dignity, and |
| | Sets priorities & manages | | respect |
| | time | | Recognizes and adheres to |
| | Facilitates change to | | guidelines dictated by |
| | enhance outcomes | | professional |
| | Humbly recognizes | | organizations/bodies/colleges/etc. |
| | uncertainty in self/practice | | Demonstrates accountability |
| | Improves systems of care | | Does not avoid important issues |
| | | | or events |
| | | | Promotes a safe learning |
| | | | environment |
| | | | Promotes patient safety |
| | | | Recognizes hidden curriculum |
| | | | Respects peers and clients |
| 9. | Resilience | 10. | Self-Awareness |
| | “Ability to successfully adapt to and | | “Ability to actively identify, reflect on, and |
| | learn from adversity and change.” | | store information about one's self.” |
| | Makes good use of | | Takes responsibility for own |
| | feedback | | actions |
| | Negotiates and manages | | Reflects thoughtfully on past |
| | change | | actions and what has been |
| | Adjusts behaviour | | learned |
| | appropriately | | Incorporates this learning into |
| | Tolerates stress | | future behaviour |
| | Demonstrates resilience in | | Understands and can articulate |
| | the face of obstacles | | own strengths and weaknesses |
| | Adapts to unforeseen | | |
| | circumstances | | |

System 100 can implement test item creation and review. Detailed examples of the item creation and review process as used for testing and AVR are described herein.

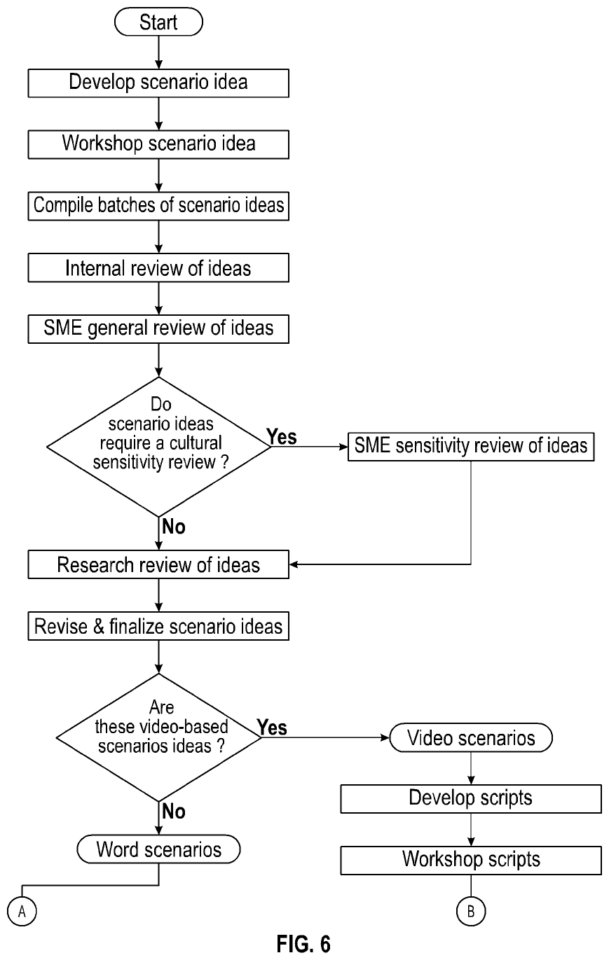

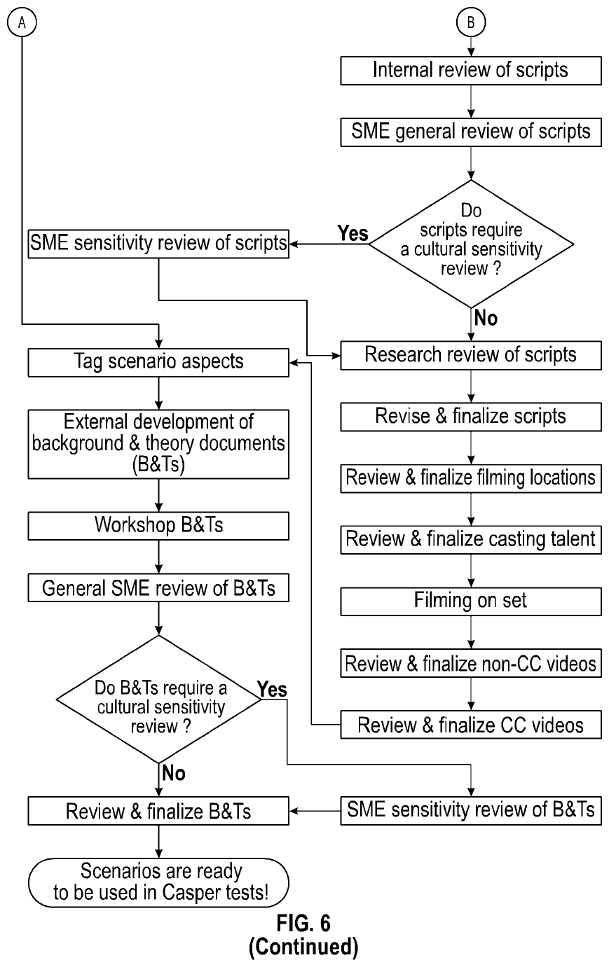

FIG. 6 is an example process for test item creation and review. System 100 can use testing engine 120 to generate or create test items for online testing. System 100 can store test items in a bank on database that can subsequently be retrieved for test compilation. The items can be used for scenarios. There can be video-based or word-based scenarios. The items or scenarios can target different levels. The item stems can be used to develop scripts for audio and/or video. Each production cycle can consist of multiple scenarios. There can be additional scenarios so that if any are unfavourably reviewed or not possible to convert to AVR then there can be replacements. Scenarios can be directed to different aspects or topics.

Item stems can be generated in a variety of ways. For example, testing engine 120 can have content generators, or connect to external content generators to receive content for item stems. There can be a content interface form to receive data for content generators. The item stems can be reviewed internally or externally. If the item stems is directed to a geography or group or expertise then members from the geography or group or expertise can review the item stems. The item stems can be directed to one or more aspects. Content generation can involve generating item stems, scripts, and video.

System 100 can implement test compilation and review. Example aspects of the process of test compilation and review, as applied to testing and AVR are provided herein.

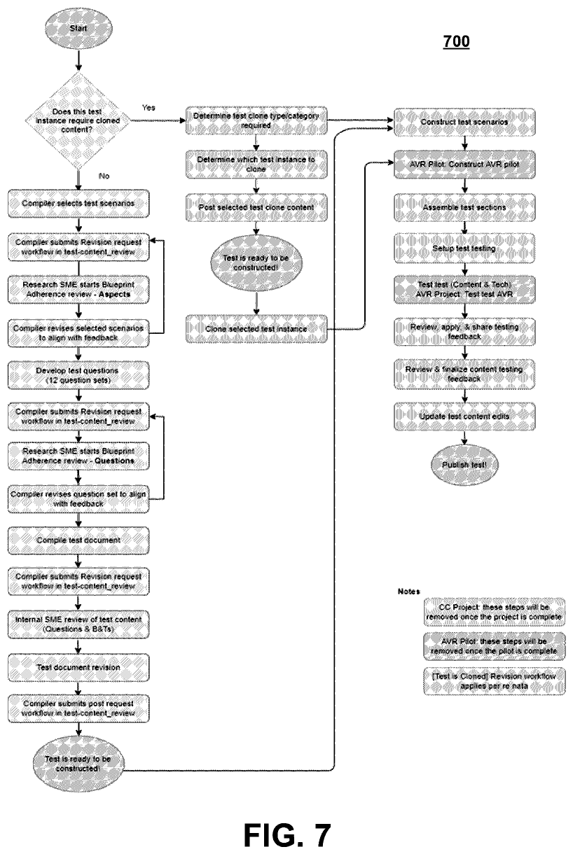

FIG. 7 is a diagram of an example process flow for test compilation and review. Test compilation involves selection of items for tests. For example, a test can involve selection of 12 unique items per test (8 video-based, 4 word-based) by system 100 from the content bank and then system 100 compiles these items into a test. Each scenario can be tagged by system 100 with primary aspects (e.g. 2 to 3), and each aspect has an associated question set(s) and background/theory description. System 100 can use a “test blueprint” for different verticals and geographies to create a balanced test.

To prepare for test compilation, system 100 can confirm test dates and required test type. A test can be cloned.

If a unique test is required, the system 100 can open or create a Usage Tracking document, a test blueprint, and an applicant demographics document. System 100 can determine the test geography, language, programs, level and applicant demographics using the applicant demographics document. System 100 can determine the required scenario types for the given test. In lieu of a content storage bank, the Usage Tracking document can be organized by scenario type, production cycle and/or geography. The Usage Tracking document can track the following: all usage, usage across verticals, usage of each scenario retired content, primary aspect tags for each scenario, scenario types, scenarios that should not be used for certain geographies, verticals, etc. System 100 can provide an interface for test compilation with selectable electronic buttons or indicia to select test items, scenarios, questions, etc. System 100 receive test selections from the interface and compiles content for the test. A user can hover over scenario titles to quickly check actor diversity from the thumbnails, for example. A Content Masterlist includes a summary of each scenario. The summaries for scenarios in a given test are provided to programs when requested.

System 100 can generate and use an aspects document for tracking purposes for test content. The aspects document provides a template for a given test. System 100 can use the template to fill in each item, and select test content (e.g. word-based and video-based scenarios), record all of the titles in the document. System 100 can link each video-scenario title to the associated video. This can help check for actor diversity, reference the video during content selection, question development, and so on. System 100 can identify each word-based and video-based scenario's associated cycle (e.g. “C3”). System 100 can identify the selected primary aspect for each word-based and video-based scenario. All potential primary aspects are found in the Usage Tracker or each scenario's associated background and theory document. System 100 can link each primary aspect to the scenario's associated background and theory document.

System 100 can use blueprint for content selection. For example, the blueprint can indicate a number of section for AVR.

Once system 100 has finalized the aspects for a given test, system 100 creates a copy of the document. System 100 can store the new document in the database. System 100 can develop question sets. System 100 can ensure that all questions are relevant and appropriate for the given vertical and geography. System 100 can ensure that every question set has at least one or more unique (new) questions. System 100 can ensure that each question set probes for the selected primary aspect for a given scenario. System 100 can add all of the sub-aspects to the document beside each scenario's primary aspect. System 100 can review the test to confirm questions are unique, layered, and aspect-specific.

System 100 can edit content for tests. System 100 can paste finalized test questions into the test document and indicate the primary and sub-aspects(s) for each scenario. Once the test content has been approved, system 100 can share the compiled test to review the test and make final test edits.

System 100 can implement parallel test form creation. In order to allow fair comparison of test results of different individuals across test instances, the test format can remain identical while test content is designed to be parallel, i.e. different from test date to test date, but comparable in level of difficulty and group differences.

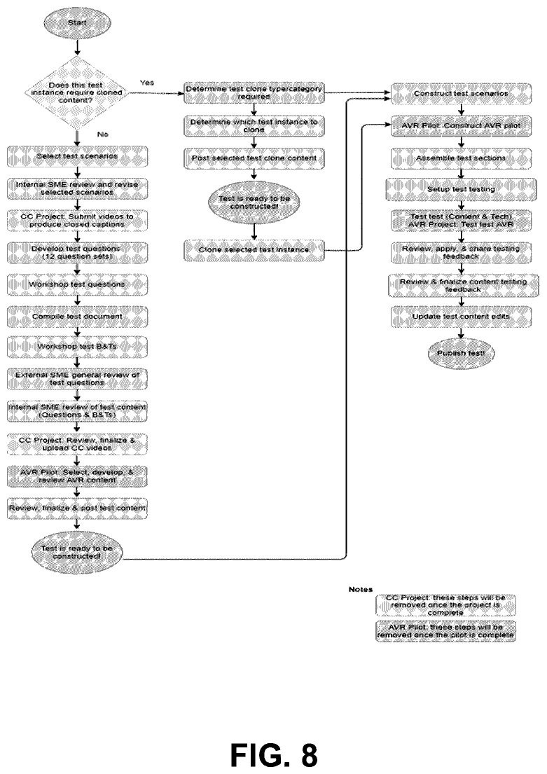

FIG. 8 is a diagram of an example process flow for test compilation and test construction.

To select content, system 100 can consider different categories. Among other things, following this blueprint ensures a wide variety of responses, allowing raters to assess the targeted ability or behaviour. The following table provides example categories which can be codified as rules for system 100. This is an illustrative non-limiting example.

| Category | Rules | | |
|---|---|---|---|
| Item Types | 4 video stems + 2 text stems | | |
| Aspects | | 1. | All 10 aspects should appear at least once, as either a primary or secondary |
| | | | aspect. |
| | | 2. | All 6 items should have unique primary aspects. |
| | | 3. | Professionalism should NOT be included as a primary aspect. |
| Usage | | 1. | As a rule, select scenarios that have not already been used in the current |
| | | | test cycle. |

| | |
|---|---|
| a. | When this isn't possible, consider how many applicants took the test |
| | that the content you're considering using was in (a lower number is |
| | preferable), and/or use a different aspect/question set than was |
| | previously used. |

| | |
|---|---|
| 2. | General usage guidelines: |

| | |
|---|---|
| a. | Avoid using a scenario more than once every 1 month, across all |
| | verticals in which it is applicable |
| b. | Avoid using a scenario more than once every 3 months for the exact |
| | same vertical |

| | |
|---|---|
| 3. | Check if the video is appropriate for the geography/vertical in question. |

| | |
|---|---|
| a. | Some scenarios are only appropriate for their specific vertical (i.e. |
| | HS1 and HS3) - this is recorded in Usage Tracking. |

| | | |
|---|---|---|
| | 4. | Once you have selected your content, be sure to record it in Usage Tracking, |
| | | in the appropriate column, using this format: “Sept 17/22;”. It is important to |
| | | include the “;” because the document calculates the total number of times |
| | | scenarios are used based on the colons. |
| Dilemma/Theme | 1. | Each scenario can present a unique dilemma and/or theme. Consider the |
| | | ‘core’ of the dilemma, separate from the scenario's specific information, when |
| | | deciding on this. |

| | |
|---|---|
| a. | applicants should not be able to respond to the dilemma with an |
| | answer similar to what they responded in another item. |
| | i.e. avoid using two scenarios where the dilemma is . . . |

```
  telling someone sensitive information
  deciding between relationships and professional obligations
  how to communicate with someone in a position of authority
  etc.
```

| | | |
|---|---|---|
| | 2. | The selected content should present applicants with a variety of boilerplates |
| | | (e.g. You are a friend. You are a co-worker., etc.). |
| Plot Points | 1. | Similar to #3, scenarios should not overlap in terms of plot points (that is, |
| | | what you ignored in #3: the specific information and details of a scenario). |

| | |
|---|---|
| a. | Rule of thumb: applicants should not recognize the same story |
| | elements in more than one scenario. |
| | i.e. avoid using two scenarios where the details include . . . |

```
  a cash incentive
  a team where one person isn't doing their part
  two friends discussing a third
  similar occupations
  students discussing something with a coach or teacher
  etc.
```

| | | |
|---|---|---|
| Setting | 1. | Tests should include a variety of settings. Aim to include a maximum of 2 |
| | | scenarios set in any given location (office, school, home, restaurant, doctor's |
| | | office, store, etc.). |
| | 2. | Production companies sometimes reuse settings (and, less regularly, props |
| | | or decorations). The exact same set should never be used twice in one test. |
| Actors & Character | 1. | As with sets, ideally, any given actor should never be seen more than once in |
| Names | | a test. |

| | |
|---|---|
| a. | If absolutely necessary (typically for French, as the content bank is |
| | slimmer), ensure the actor is in a similar role in both scenarios (i.e. |
| | both feature the actor in a supervisory office job) |

| | |
|---|---|
| 2. | Actor diversity in a test should match the diversity makeup of the country for |
| | which the test is being created. |

| | |
|---|---|
| a. | Avoid including more than 1-2 scenarios with exclusively white |
| | actors. Include a minimum of 1-2 scenarios with exclusively non- |
| | white actors. |

| | | |
|---|---|---|
| | 3. | Avoid the repetition of any character names, both for the speakers and other |
| | | characters mentioned in video scenario dialogues, in a test. |
| Other | 1. | Consider the age-appropriateness of a vertical. |

| | |
|---|---|
| a. | For example, scenarios that mention alcohol are not appropriate for |
| | HS1, as they are not of legal drinking age and should not be |
| | expected to have any knowledge of this topic. |

| | |
|---|---|
| 2. | Word-based scenarios are typically reused more frequently than Video |
| | scenarios. Keep in mind their frequency of use, and use new questions |
| | wherever possible |
| 3. | Group specific scenarios can be varied for different markets |

The following table provides example aspect definitions for AVR and test responses.

| Aspect | Definition | Targeted Behaviours |
|---|---|---|
| Collaboration | “Ability to function | Demonstrates safe handover of care |
| | interdependently by balancing | Engages in multi-perspective conversations |
| | individual & mutual goals and | Establishes & maintains relationships with peers |
| | demonstrate an openness to | Learns collaboratively |
| | others' perspectives & input, all in | Negotiates shared responsibilities and decision- |
| | service of reaching consensus and | making |
| | achieving a larger mission.” | Self-sacrificing in favour of team |
| | | Shares knowledge readily |
| | | Works towards shared goals humbly |
| | | Works with community to determine issues |
| Communication | “Ability to effectively interact with | Communicates clearly and respectfully |
| | the intent of understanding and | electronically |
| | being clearly understood in | Effectively conveys information |
| | different contexts.” | Facilitates discussion |
| | Internal note: without necessarily | Listens effectively |
| | reaching an agreement | Negotiates and manages conflicts |
| | | Understands non-verbal behaviour |
| | | Provides feedback |
| | | Provides clear and accurate explanations |
| | | Adjusts communication approach depending on |
| | | situation |
| Empathy | “Ability to take the perspective of | Assesses learners respectfully |
| | another person's feelings and | Humbly recognizes uncertainty in professional |
| | context in a given situation.” | contexts |
| | | Sensitive to others' needs |
| | | Supports colleagues in need |
| | | Displays compassion and care in interactions |
| Equity | “Ability to acknowledge, | Responds to individual patient circumstances |
| | appreciate, and respect the | Recognizes & addresses communication barriers |
| | individual & cultural values, | Respects diversity & individuality |
| | preferences, experiences, and | Knowledge of socio-cultural factors |
| | needs of others.” | Recognizes & addresses personal biases |
| | Internal note: expressed and | Appreciates & understands diversity |
| | internalized needs | |
| Ethics | “Ability to maintain a set of moral | Encourages healthy and moral behaviour |
| | principles (namely respect for | Fulfils codes of ethics |
| | autonomy, goodwill, integrity, | Demonstrates moral reasoning |
| | honesty, and justice) that dictate | Cultivates integrity and honesty |
| | personal and professional | Identifies and adheres to ethical principles |
| | behaviour.” | Remains honest and trustworthy |
| | | Encourages trust |
| Motivation | “Ability to reflexively, actively, and | Desire to continuously improve |
| | persistently apply oneself to | Reflects on own learning and self |
| | achieving one's personal best.” | Makes good use of feedback |
| | | Improves personally |
| | | Understands own skills & limitations |
| Problem Solving | “Ability to recognize and define a | Seeks & synthesizes relevant information |
| | problem, develop a process to | Demonstrates critical & evidence-based reasoning |
| | tackle it, and evaluate the | Sets priorities & manages time |
| | approach for its efficacy.” | Facilitates change to enhance outcomes |
| | | Humbly recognizes uncertainty in self/practice |
| | | Improves systems of care |
| Resilience | “Ability to successfully adapt to | Makes good use of feedback |
| | and learn from adversity and | Negotiates and manages change |
| | change.” | Adjusts behaviour appropriately |
| | | Tolerates stress |
| | | Demonstrates resilience in the face of obstacles |
| | | Adapts to unforeseen circumstances |
| Self-Awareness | “Ability to actively identify, reflect | Takes responsibility for own actions |
| | on, and store information about | Reflects thoughtfully on past actions and what has |
| | one's self.” | been learned |
| | | Incorporates this learning into future behaviour |
| | | Understands and can articulate own strengths and |
| | | weaknesses |
| Professionalism* | secondary aspect | Creates environments prioritizing safety, comfort, |
| | “Ability to acknowledge one's | dignity, and respect |
| | responsibilities as a professional | Recognizes and adheres to guidelines dictated by |
| | by demonstrating and maintaining | professional organizations/bodies/colleges/etc. |
| | high personal standards of | Demonstrates accountability |
| | thoughtful, accountable, | Does not avoid important issues or events |
| | respectful, and regulated | Promotes a safe learning environment |
| | behaviour.” | Promotes patient safety |
| | | Recognizes hidden curriculum |
| | | Respects peers and clients |

System 100 can generate different general categories of test instances. Example general categories of test instances are: independent tests and mirror tests. The following provide example (non-limiting) tests.

### Independent Tests

### 1. Unique Test

100-5000+ applicants
12 scenarios that have never before been used altogether
If a scenario has been used in a previous test, at least one question per set is new/unique

### 2. Indirectly Cloned Test

100-5000+ applicants
Utilizes the same scenarios as another (parent) test, but with entirely unique question sets.
   The question sets use the same aspects and probe for similar behaviours, but (to prevent cheating) are framed uniquely.
Used under the following circumstances:
   Same vertical AND
   Same test date, but different time slot (e.g. US HS2 at 5 pm & 8 pm on the exact same day)

### 3. Directly Cloned Test; Different Timeslot

1-100 applicants (except in specific circumstances)
An exact copy of a previous unique (parent) test
Used under the following circumstances:
   Same vertical AND
      Expected applicant registration of under 100 (60 applicants required to produce a reliable z-score) OR
      Previously decided upon by program/CSM OR
      Emergency tests (e.g. COVID MMI replacements) OR
      Pilots OR
      An applicant qualifies for a backup test as determined by Applicant Support and/or CSMs OR
      To reduce content burn

### Mirror Tests

Tests that occur in the exact same timeslot as a unique (parent) test and utilizes identical content. NOTE: A “mirror test” is not used for calculating scenario usage. A mirror test presents the same content, at the same time, as a given unique test. Because of this, these mirror tests pose a negligible to non-existent additional content security risk.

### 4. Directly Cloned Test; Same Timeslot

60-5000+ applicants
A “mirror” copy of a Unique test that is administered in the exact same timeslot
For all security purposes, this version of a test is effectively the same as the unique (parent) test.
For the 2021/22 cycle, tests that took place at the exact same time and date for the following groupings of verticals were mirror cloned:
   AUS
      ED1, ED2, Vet 1&2, Nursing 1
   CAN (EN)
      HS1, ED1
      HS2, ED2, SCI2, Paramedics 2
   CAN (FR)
      HS1, ED1
   US
      HS2, MED

### 5. Closed Captioned (CC) Test

applicants requiring accommodations
A “mirror” copy of a Unique test, run in the same timeslot.
For all security purposes, the CC version of a test is effectively the same as the Unique test

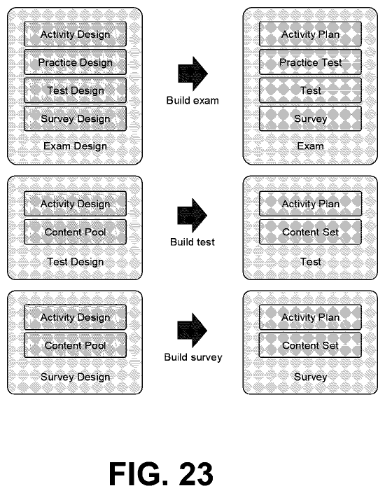

FIGS. 23 to 28 are example diagrams relating to composing exams for system 100 for online testing.

System 100 can implement test compilation using templates. FIG. 23 shows an example template of designs for building tests or exams.

Exam designs can be specific to a test cycle. Exams can be specific to a particular date and time. Exams can be built from exam designs. Exam designs contain designs for tests and surveys. Exams contain tests and surveys that are built from corresponding test designs and survey designs. Tests and surveys contain content sets that are drawn from content pools. Activity designs define the rules (timing, conditionals, and so on) for the sequencing of activities. Activity plans are built from activity designs and may take into account conditions specific to the exam.

The following provides an overview of exam context terminology. An exam is a collection of activities supporting the assessment of people. An activity is a structured mechanism for interacting with people (e.g. configuring a webcam, practicing, taking a test, responding to a survey). Some activities may be composed of other activities. An assessment is a collection of activities supporting a specific test format within an assessment family. An assessment family is a collection of assessments that use similar tests and evaluation methods. An assessment cohort is a window of time associated with a collection of assessments mapped to specific content pools.

The following provides an overview of content context terminology. A test is a collection of prompts and associated rubrics. A survey is a collection of prompts. A content pool is a managed collection of prompts. The pool enforces rules covering when a prompt can be used. A prompt is one or more scenarios, questions or statements intended to elicit a response. A response is a collection of user inputs captured after presenting the user with a prompt. Scoring rubrics are used to facilitate rating of responses to test items.

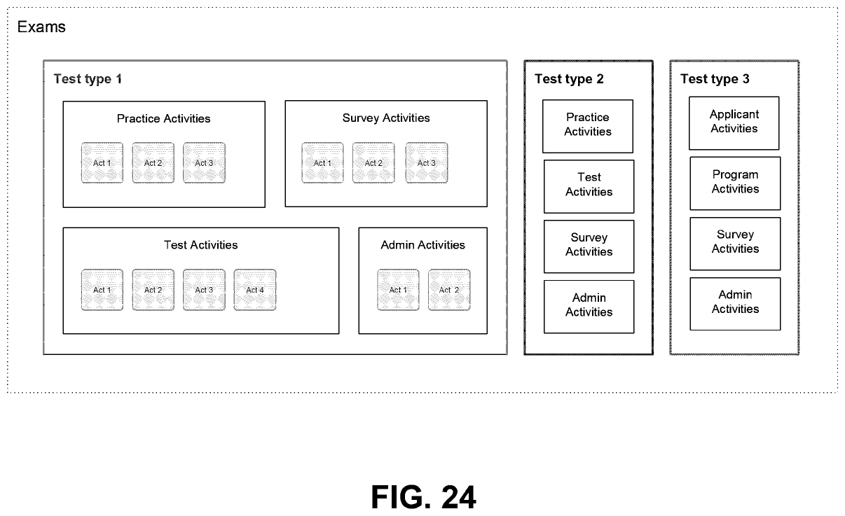

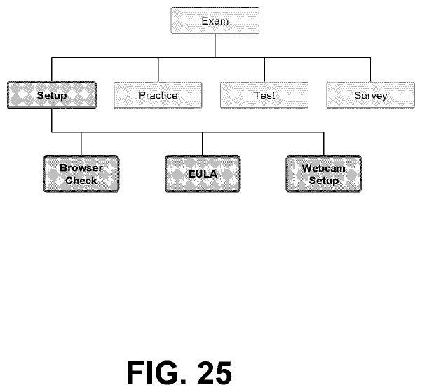

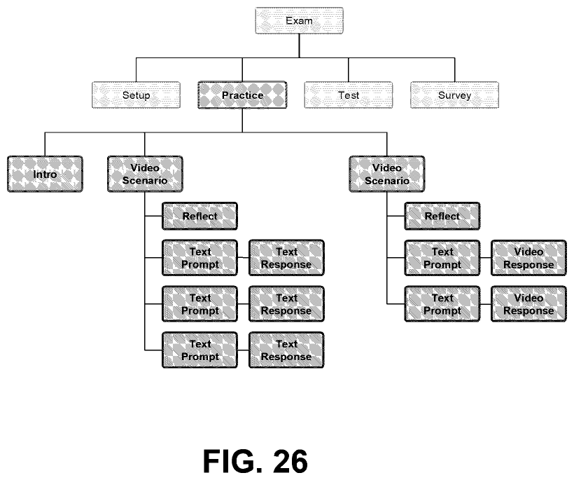

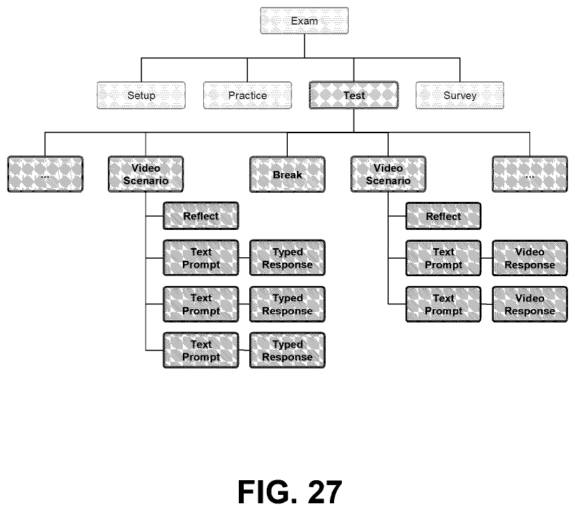

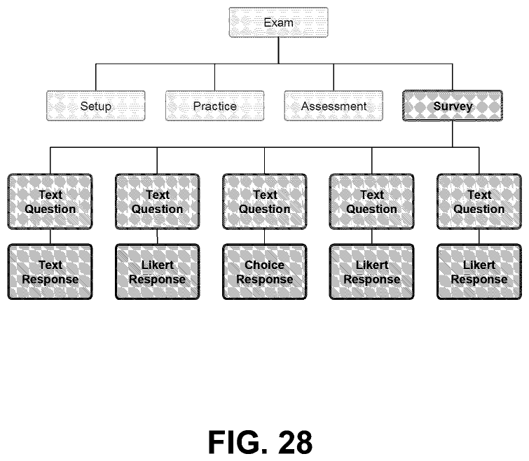

FIG. 24 is a diagram for exam composability for different types of tests or exams. FIG. 25 is a diagram of example set up activities. FIG. 26 is a diagram of example practice activities. FIG. 27 is a diagram of example test activities. FIG. 28 is a diagram of example survey activities.

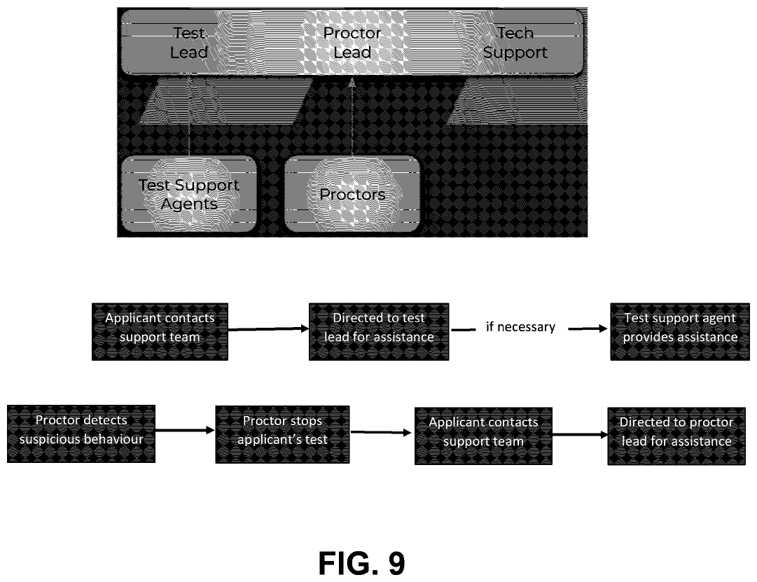

System 100 can implement in-test support. The online tests can be administered with support from a team that can be broken down into different functional areas. FIG. 9 a schematic diagram of example in-test support.

Test support agents can provide live, direct support to applicants via an online messaging platform. System 100 can use proctor service to implement test support. The support agents can assist with real-time inquiries or concerns that applicants may raise during an online test, ranging from procedural questions to troubleshooting technical issues. Test support agents are guided by system 100 that provides overall direction for the support.

Proctors can use the proctor services of system 100 to monitor applicants for compliance with testing rules and stop applicants' tests when necessary. This can be done using video data supervision, with the assistance of technology that detects and alerts the team to suspicious behaviour. Proctors are directed by a team lead (Proctor Lead), who also directly engages with applicants to investigate and resolve unusual or problematic behaviours.

Technical support team can oversee the technological aspects of test administration (e.g. server and database performance), ensuring the test delivery is functioning as intended. The technical support team can also assist test support agents with investigating and resolving applicants' technical issues using the system 100.

System 100 can implement different standardized tests for admission into different types of programs and schools such as medical school and business school, or for selection to positions in industry, or in governmental endeavours. System 100 can implement validity analyses for tests including but limited to correlational analyses, factor analyses, and item response analyses.

System 100 can implement correlational analyses. System 100 can implement correlations with multiple mini-interviews (MMIs), interview scores, and other measures of support as a measure of its intended construct. At the same time, the correlations are not so high as to indicate that system 100 is redundant with these other metrics. Instead, mid-range correlations suggest that system 100 is providing unique information that may not be attained through traditional admissions metrics. Additionally, system 100 can displays either minimal or negative correlations with assessments of technical abilities or cognitive achievement across several programs and multiple countries. This indicates that system 100 may not be measuring the same underlying construct(s) as technical metrics such as MCAT and GPA. Further, system 100 shows meaningful associations with a range of exam scores and in-program behaviour. The level of predictive ability surpasses that of other SJT tools and matches that of technical or cognitive/knowledge measures used in different admissions processes. System 100 has an ability to predict applicant performance on licensure exams, performance on in-program measures of success (e.g. OSCE exams, clerkship grades, etc.), interview scores, and professional behaviour. System 100 scores may not be impacted by spelling, grammar, reading level, or test preparation. Taken together, this set of evidence indicates that system 100 is an effective measure of tests for soft skills and is not influenced by numerous irrelevant variables.

System 100 can implement factor analysis (FA). FA is a statistical technique that evaluates the inter-correlations of a set of items (e.g. test scenarios) to form a parsimonious rendering of the test's structure. FA tells us what items of a test cluster together and the extent to which they belong together. The underlying theory of FA is that test items are correlated with one another because of a common unobserved influence; this unobserved influence is referred to as the latent variable. Latent variables cannot be directly measured or observed and thus must be inferred from other observable or measurable variables.

System 100 can implement Exploratory Factor Analysis (EFA). As the name suggests, EFA is used early on in test construction to determine how a set of items relate to (or define) underlying constructs. EFA can be described as a theory-generating method as researchers do not conduct an EFA with certain expectations or theories in mind, but rather allow the structure within the data to reveal itself, the results of which are used to develop a theory of the test's structure. For system 100, a series of EFAs can be conducted for several test instances across each application cycle. Since the content of each test is unique, it is important to continuously assess these properties to ensure that results are consistent across test instances. For all EFAs conducted on system 100, a maximum likelihood extraction method can be used. If data are relatively normally distributed, then this method allows for the computation of a wide range of indices of the goodness of fit of the mode and permits statistical significance testing of factor loadings. To determine how many factors should be retained, system 100 can rely on results from parallel analysis, which has been suggested by some to be an accurate method for determining factor retention. Parallel analysis requires several random datasets to be generated (i.e. a minimum of 50) that are equal to the original dataset in terms of the number of variables and cases; thus, making them ‘parallel’ to that of the original. Factors are retained if the magnitude of the eigenvalues produced in the original data are greater than the average of those produced by the randomly generated datasets. The underlying theory of parallel analysis is that the eigenvalues derived from random datasets can only be considered statistical artifacts, thus when the original dataset produces greater eigenvalues, they provide information beyond that which is considered a statistical artifact. There can be a one-factor structure to best fit for approximately 97% of tests. It is important to note that a single-factor structure is also supported by the consistently high coefficient alpha values which indicate that test items are intercorrelated and measure the same, underlying construct.

System 100 can implement Confirmatory Factor Analysis (CFA). Following theory development, system 100 can conduct a CFA to confirm that the test's structure matches that which was proposed theoretically. At a high-level, the process of conducting a CFA involves imposing a model onto a dataset to evaluate how well the model fits the data. EFAs suggest that for a one-dimensional test, a one-factor model can be imposed on the data. The degree to which this model fit the data was evaluated using the following fit indices: (i) comparative fit index (CFI), (ii) root-mean-square error of approximation (RMSEA), and (iii) standardized root-mean-square residual (SRMR). Across all data sets the fit indices supported “good” fit of the one-factor model (e.g. each of the fit statistics met the threshold for a ‘good’ fit).

System 100 can implement Item Response Analyses. Demographic differences in test performance can potentially arise when demographic subgroups have different interpretations, or have preferential knowledge, of certain test scenarios. Differential Item Functioning (DIF) allows system 100 to detect when a scenario is biased in this way. Item Response Theory (IRT) and DIF can be employed to evaluate whether or not there was nay bias inherent in the test scenarios and associated questions. The presence of DIF can indicate bias while the absence of DIF indicates scenarios and questions are free from bias. Specifically, DIF was examined from the perspective of ethnicity, gender, and age. DIF occurs if and only if, people from different groups with the same underlying true ability have a different probability of obtaining a high score. DIF can be modeled using ordinal logistic regression. To test for model significance (i.e. whether DIF was present) a chi-square and a likelihood ratio test can be used to determine whether the presence of DIF was significant. These are types of statistical hypothesis tests where the parameters for a null model (i.e. a mathematical model which fits applicant responses based on ability level but doesn't include subgroup identity as part of the model) are compared to the parameters for an alternate model (i.e. a model which includes everything the null model contained, in addition to subgroup identity). The analysis can compare the difference between the parameters of the two models to a critical value, taken from, for example, the chi square distribution. This critical value is the most to be expected that the model parameters differ by, if there is truly no difference between the model fits. If the difference is greater than this critical value, then the models may be significantly different, and DIF is present. Follow up testing measures the magnitude of the difference in model fit between the null and alternate models. Based on the magnitude of the R-squared (i.e. model fit) difference between the models, the magnitude of the DIF can be interpreted as either negligible, moderate, or large. The percentage of items that evidence DIF may be uniformly low across application cycles and has continued to decrease. This means that, overall, the content of test items may be fair across all groups of applicants. When DIF is detected in an item, system 100 can conduct a qualitative review of the item to assess if any obvious signs of bias are present in the scenario or the wording of the questions.

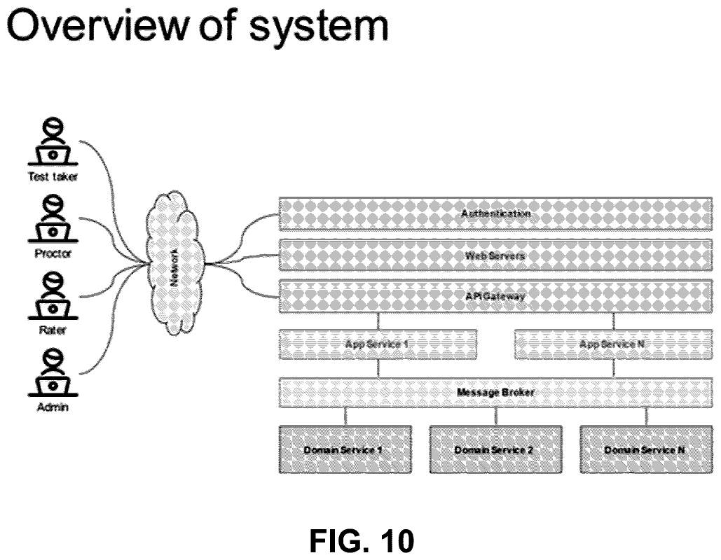

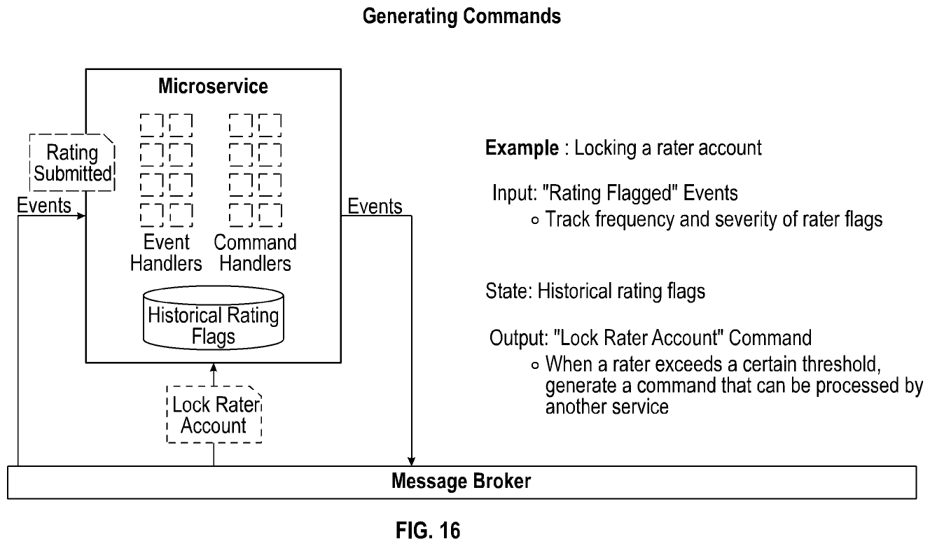

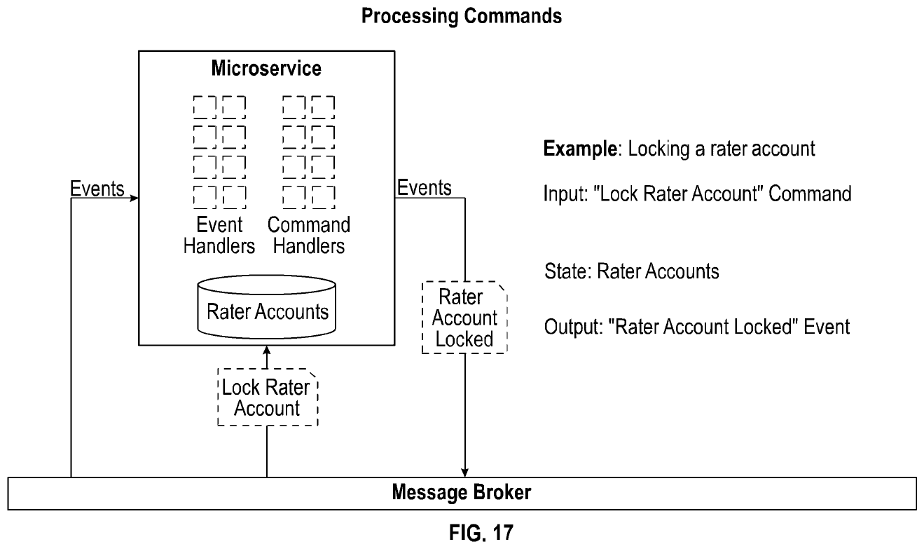

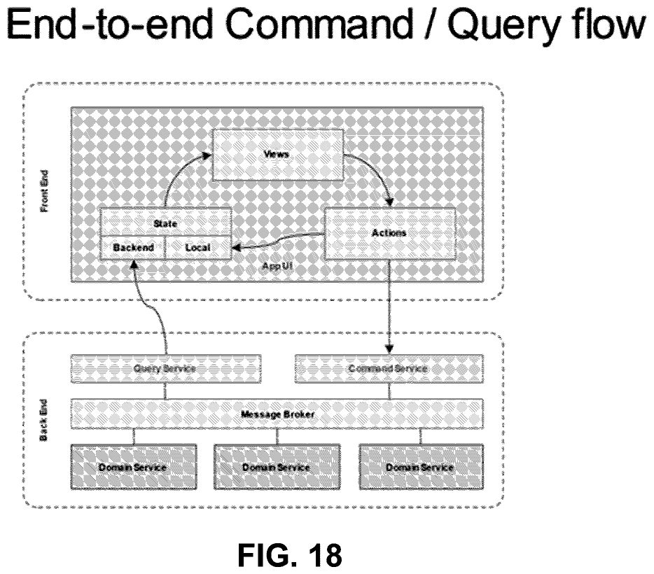

System 100 can implement a modular online test platform. Example schematics related to a modular online test platform are presented in FIGS. 10 to 18. System 100 can provide online testing with modularity, extensibility; accessibility; scalability, performance; reliability, availability, resilience. The system 100 can proving online testing with event-driven microservices, application services, message broker, domain services, workflows, commands, events, and topics.

FIG. 10 is a diagram of an example system 100 that connects to different electronic devices (e.g. test taker device, proctor device, rater device, administrator device) The system 100 can have authentication service, web servers, and an API gateway that connects to applications services. A message broker can coordinate messaging between application services and domain services.

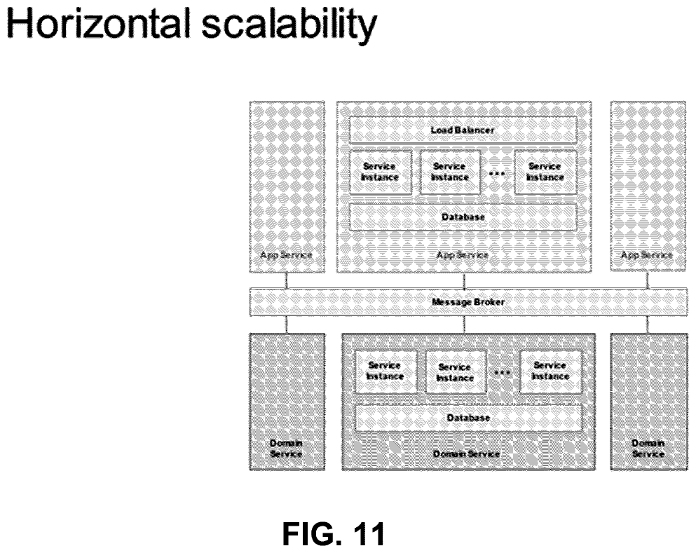

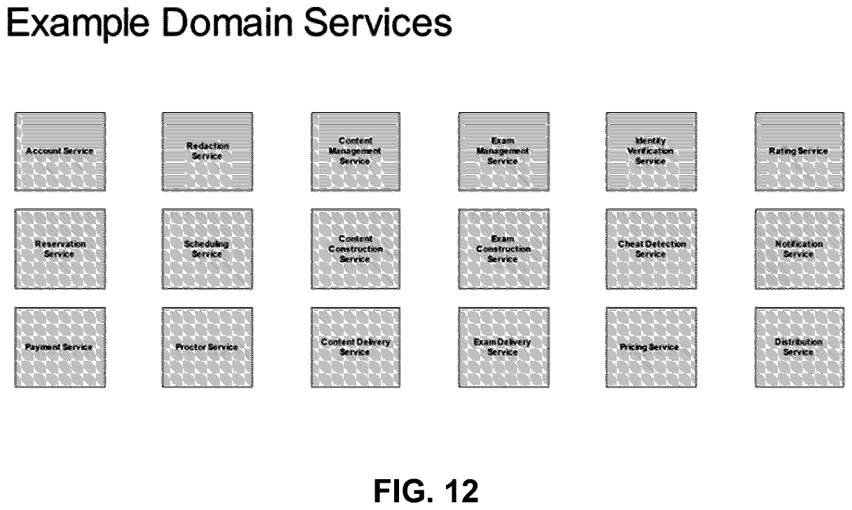

FIG. 11 is a diagram illustrating horizontal scalability of an example system 100 with multiple machines for application services and domain services that can be scaled based on traffic and demand. FIG. 12 shows example domain services including: account service, reservation service, payment service, redaction service, scheduling service, proctor service, content management service, content construction service, content delivery service, exam management service, exam construction service, exam delivery service, identity verification service, cheat detection service, pricing service, rating service, notification service, distribution service.

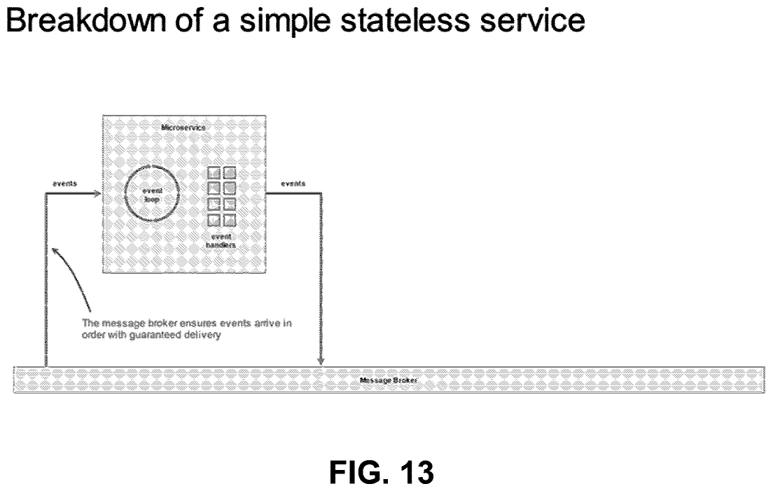

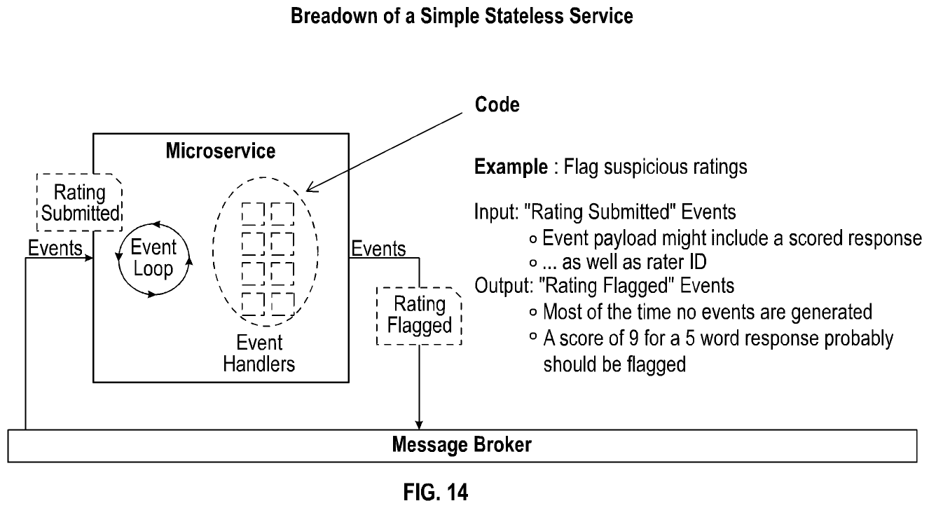

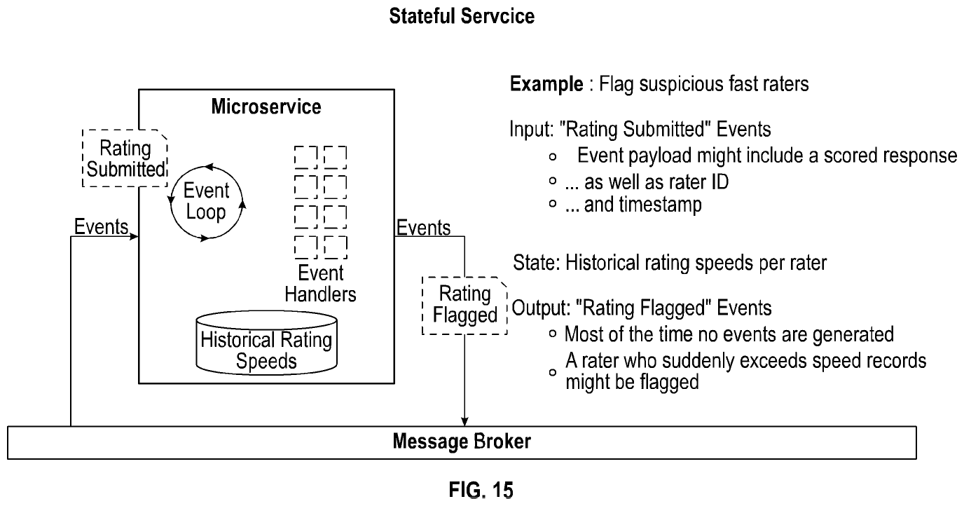

System 100 can have stateless services and stateful services. FIGS. 13 and 14 show an example stateless service. FIG. 15 shows an example stateful service. A stateful service processes requests based on its current state, and stores states internally. For example, account service needs to keep track of user profiles, user permission, and so on. However, an account service can also store states in an external database so that a stateful service can become a stateless service by externally storing state information. A stateless service processes requests without considering states. All requests are processed independently and the stateless service does not maintain an internal state. An advantage of stateless services is that they are easier to scale because you do not have to manage states.

System 100 provides online testing with accessibility. An illustrative example of accessibility with test accommodations is closed captioning. System 100 increases accessibility of tests, and implements accessibility standards and best practices. System 100 uses a service for accessibility to eliminate the need to build and administer separate closed captioning tests. System 100 can implement accessibility functionality for scenarios in tests. Closed captions are text version of the exact spoken dialogue and relevant non-speech sounds of video content. Closed captions differ from subtitles which may not be exactly the same as the dialogue or contain other relevant audio. Closed captions were developed to aid hearing-impaired people (i.e. assume that an audience cannot hear and differ from subtitles which assume that an audience can hear). Closed captions can be turned on/off by the user (differs from open captions that cannot be turned on/off). Closed captions can be identified with [CC].

System 100 can produce CC files. Each video has at least one associated SRT file (otherwise known as a SubRip Subtitle file) which is a plain text file that includes all critical information for video subtitles, including dialogue, timing, and format. Videos used in tests administered in multiple geographies require a separate SRT file for each language variant, if the geography is treated separately for testing purposes (ex. CAN-en vs. US-en). Note: This may not be the case for pilots, research projects, or smaller verticals (ex. AUS and NZ)

System 100 can implement guidelines for CC formatting. There can be font, style, and colour related guidelines for text, and guidelines for location, orientation, and background to increase visual contrast. There can also be guidelines for the amount of text display and the timing of text display for an appropriate and consistent speed. Text and closed captions can appear on the screen at all times. If there's a long pause a non-speech sound the an indicator should appear to indicate this (e.g. (pause)).

Closed captions can include non-speech sounds. This can include any sound that is off-screen (background music, someone speaking off-camera, etc.) or any sound effect that is important to the overall understanding of the plot (ex. laugh, sneeze, clap).

Closed captions can identify speaker names, even narrators. If there is a consistent narrator throughout an entire video, they may only be introduced at the beginning of the video. Names can appear on a separate line and above the rest of the closed captions.

Closed captions can accurately cover text from the video, and also have accuracy for spelling, grammar, punctuation. Grammar can express tone (i.e. use exclamation marks and question marks where appropriate). Spelling can be localized for the given market (CAN vs US vs AUS). Informal contractions can be corrected to prioritize clarity. Difficult contractions can be revised to prioritize clarity.

Applicants taking tests can toggle the closed captions on/off throughout the test. Applicant closed captions selections carry over from one video to the next.

SRT files can organized in video drives in their associated production cycle folder. SRT files can be labelled with their associated language and geography, as follows: en-CA, en-US, en-AUS, en-NZ, en-UK, de-DE, en-QA, fr-CA. SRT files can be uploaded to system 100 and attached to their associated video with tags. These tags ensure that the appropriate SRT file is displayed for their associated test masters.

Example videos include: test scenarios, introduction videos, rater training, scenarios used for other purposes (e.g. training, sales, applicant and program sample tests. The videos can be in different languages and markets.

System 100 can implement a modular online test platform using a domain service framework to create/customize, highly scalable, reliable, fault-tolerant domain services. The online test platform functionality can include exam and content construction. System 100 enables creation of new/customized assessments from building blocks. System 100 provides exam and content management, managing test dates and use of content. System 100 enables exam and content delivery, including test runner. System 100 enables applicant accessibility with localization, closed captioning, and time allotments among other considerations. Details of an example approach to applicant accessibility, including closed captioning, as it pertains to testing and AVR is provided herein.

System 100 can use artificial intelligence methodologies to automate test rating, or to provide a hybrid approach to rating. System 100 can use NLP to evaluate responses (see e.g. U.S. Provisional Patent Application No. 63/392,310 the entire contents of which is hereby incorporated by reference) and to correlate machine predicted scoring with human-rated scoring to evaluate reliability of ratings, also known as inter-rater reliability (IRR). Methodologies that enhance IRR (e.g. scoring rubrics above) can further support NLP predicted rating to human rating correlations. Increasing NLP implementation reduces dependence upon greater time and resource intensive human rating. Hybrid NLP-human approaches include, but are not limited to:

(a) Inter-item hybridization, in which some of the items in a multi-item test are scored entirely by humans, the remaining items are scored entirely by NLP. System 100 can use different models for hybridization.

(b) Intra-item hybridization, in which responses to a single item are rated by both human raters and NLP. System 100 can use different models for hybridization.

(c) dynamic and iterative automated decision-making tool to optimize hybridization solution(s). System 100 can replace human raters by optimized predictive validity correlations. System 100 can implement an AI function (independent of the NLP service 118) that iteratively incorporates trainee outcome data and determines optimized hybridization approach to attain optimal predictive validity, within predetermined constraints such as overall test reliability, group differences, and coachability.

Accordingly, system 100 can use NLP scoring 128 for hybridization of rating.

The following provides an example for inter-item hybridization.

To illustrate example effects of hybrid rating, system 100 can consider a (non-limiting) example 9 section test. System 100 can use the NLP scoring 128 engine to score three scenarios which can result in an average absolute difference of 0.19 z-scores from fully human-scored 9 scenario tests. In this example, 71% of students would see their z-scores change by 0.25 z-scores or less, and 96% of students would see their z-scores change by 0.5 z-scores or less. Accordingly, hybrid rating may provide improved results than removing scenarios entirely. Using NLP scoring 128 to rate more scenarios may increase test reliability. In this example, demographic differences are unchanged when scoring three scenarios using the NLP scoring 128 engine.

For this example, test data can be from tests administered between January 2021 and April 2022 (i.e. responses that were not used during model training), only the first submitted rating was used if multiple ratings were provided for the same response (i.e. oversampling), and the data only included tests with at least 100 applicants.

This analysis depends on recalculating z-scores based on different sized tests. Tests with fewer applicants are typically grouped with larger tests when calculating z-scores in practice. To simplify analysis, system 100 can calculate z-scores by test instance, so these smaller tests would not be accurately scored. There should, however, be no loss of generality by only including tests with at least 100 applicants. The sample data set can be for 174,419 applicants with 2,191,097 responses.

System 100 can use different methods for NLP scoring 128. For example, system 100 can randomly selected 9 scenarios from each test instance. These randomly generated 9 scenario tests will be used as the base tests, assuming that they reflect the tests students would have taken had they completed a 9 scenario test rather than a 12 scenario test. System 100 can re-calculate students' z-scores based on the 9 scenario test. From the 9 scenario test, system 100 can randomly choose X scenarios to be rated by humans (X={4, 5, 6, 7, 8}). System 100 can compare z-scores with all 9 scenarios rated by humans to z-scores with X scenarios rated by humans and (9-X) scenarios rated by NLP scoring 128.

Below, the metrics quoted all compare the z-scores with all 9 scenarios scored by humans and z-scores with 1-5 scenarios scored by the NLP scoring 128 engine.
MAE=Mean absolute error
ICC=Intraclass correlation coefficient
QWK=Quadratic weighted kappa

“% within X z-scores” reflects the percent of students whose z-scores with 1-5 scenarios scored by the engine fall within X z-scores of their z-scores with all 9 scenarios scored by humans.

| | | | | | % within | % within | % within |
|---|---|---|---|---|---|---|---|
| N scenarios | | R- | | | 0.1 z- | 0.25 z- | 0.5 z- |
| scored by Al | MAE | squared | ICC | QWK | scores | scores | scores |
| 1 | 0.10 | 0.98 | 0.99 | 0.95 | 58 | 93 | >99 |
| 2 | 0.15 | 0.96 | 0.98 | 0.93 | 41 | 81 | 99 |
| 3 | 0.19 | 0.94 | 0.97 | 0.91 | 33 | 71 | 96 |
| 4 | 0.22 | 0.92 | 0.96 | 0.90 | 29 | 63 | 92 |
| 5 | 0.26 | 0.89 | 0.95 | 0.88 | 25 | 57 | 88 |

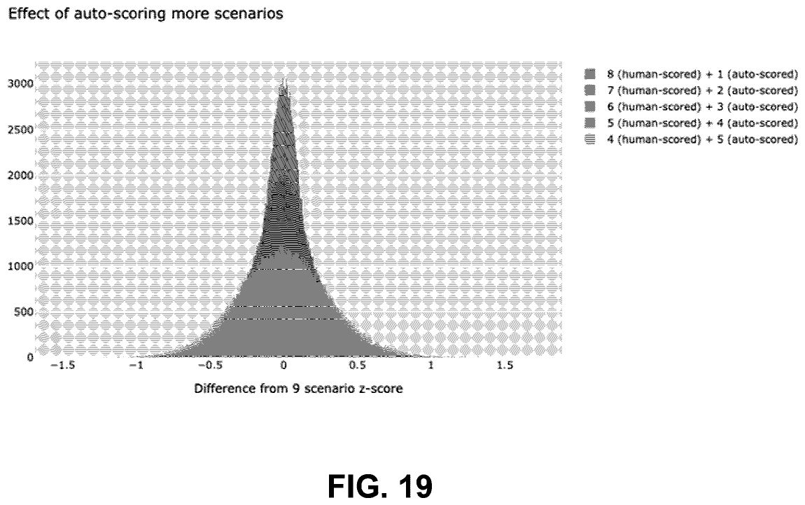

FIG. 19 shows an example graph of results for using NLP scoring 128 to automatically rate or score scenarios. Using the NLP scoring 128 engine to score three scenarios show an example result of an average absolute difference of 0.19 z-scores from fully human-scored tests. 71% of students have z-scores change by 0.25 z-scores or less. 96% of students have z-scores change by 0.5 z-scores or less.

The following table shows results from reducing the size of the test without using the NLP scoring 128 engine.

| | | | | | % within | % within | % within |
|---|---|---|---|---|---|---|---|
| | | R- | | | 0.1 z- | 0.25 z- | 0.5 z- |
| Type | MAE | squared | ICC | QWK | scores | scores | scores |
| 6 human-scored | 0.22 | 0.92 | 0.96 | 0.90 | 29 | 65 | 93 |
| scenarios | | | | | | | |
| 6 human-scored | 0.19 | 0.94 | 0.97 | 0.91 | 33 | 71 | 96 |
| scenarios + 3 auto- | | | | | | | |
| scored scenarios | | | | | | | |

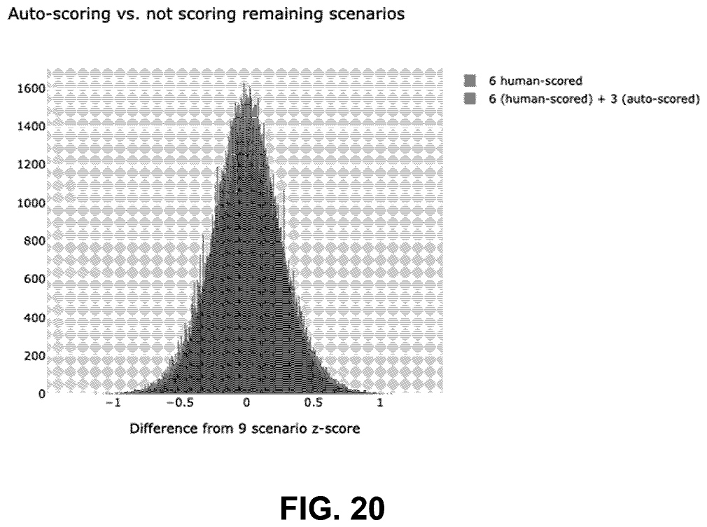

FIG. 20 shows an example graph of results for comparing automated scoring by NLP scoring 128 engine and scoring that does not use the NLP scoring 128 engine. The example results indicate that auto-scoring scenarios is better than removing scenarios entirely. Overall, hybrid rating will provide results that are closer to nine scenario results than simply dropping scenarios entirely.

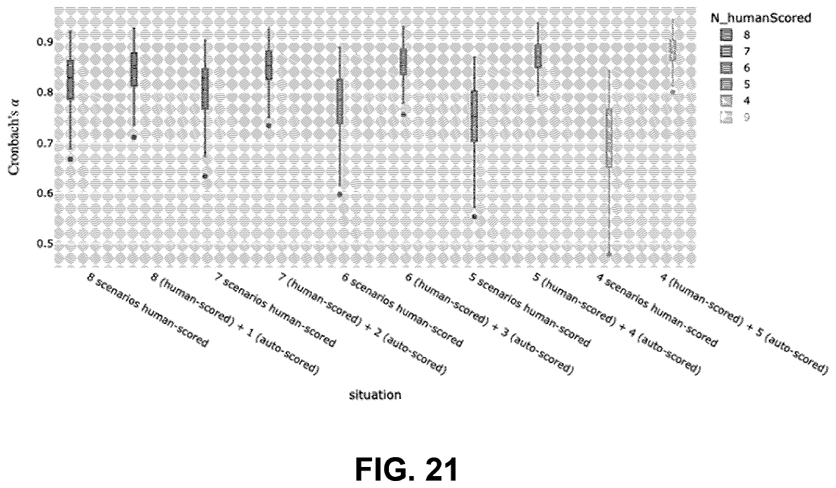

FIG. 21 shows an example graph of boxplots to show the reliability of each test in the dataset under each of the different rating scenarios considered.

Without auto-rating the remaining scenarios (i.e. just removing scenarios), test reliability can generally decrease. Auto-rating more scenarios may have the effect of increasing test reliability. For example, tests with human-rated scenarios and auto-rated scenarios can generally have a higher reliability than only human-rated scenario tests. This result may come about because of the nature of the predictive model.

The model applies the same criteria to every scenario. If students respond in similar ways to all scenarios then they will receive similar scores on all scenarios. The model works because students do respond in similar ways to (almost) all scenarios, hence the extremely high reliability for a test with all scenarios scored by the NLP service 118 (with NLP scoring engine). If students' response patterns differed by scenario, then the auto-rated test reliability may be lower and system 100 would likely not be able to use a scenario-agnostic model at all. Whereas test reliability is usually subject to variability in how students respond to different scenarios and how different raters interpret responses, automatically rating responses is only subject to variability in how students respond to different scenarios (i.e. there is no interrater variability). Auto-rating more scenarios can only increase the test reliability.

System 100 can accommodate and evaluate demographic differences. System 100 can evaluate demographic differences by comparing the Cohen's d for human-scored scenario tests with a combination of human-scored and auto-scored scenario tests, or with only auto-scored scenario tests.

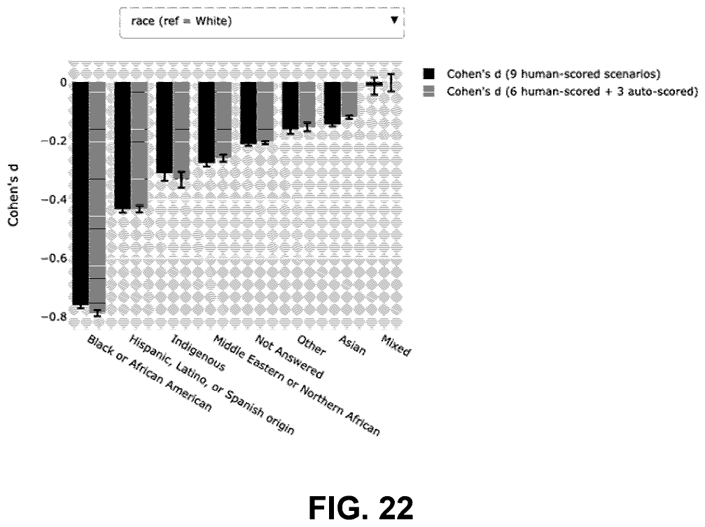

FIG. 22 shows an example graph of results for demographic differences. System 100 can generate graphs for gender, age, ethnicity, race, and gross income. This is an example graph for ethnicity. For all variables, demographic differences can be the same across both types of scoring. The example shows that differences in Cohen's d are all less than 0.03.

As noted, system can use NLP service 118 for automated scoring of tests. There can be cost savings for using NLP service 118 for automated scoring, and efficiency improvements.

There can be alternative methods of employing hybrid rating using NLP service 118.

Hybrid rating can assume that some subset of scenarios were rated by humans and the other scenarios were rated automatically using NLP service 118.

In addition to the methods described above, there are other methods to employ hybrid rating.

Another example method for hybrid rating involves humans rating x scenarios (score1), and using NLP service 118 for automated rating of (y-x) scenarios (score2). System 100 can calculate z-scores of score1 and (score1+score2). Depending on the difference between the scores (which codified as a threshold value), then humans can re-rate additional (y-x) scenarios to use in z-scoring. Otherwise use (score1+score2) for z-scoring, or use only x scenarios in z-scoring.

Another example method for hybrid rating involves humans rating x scenarios (score1), AI rates y scenarios (score2). System 100 can calculate z-scores of score1 and (score1+score2). Depending on the difference (based on threshold value) between the scores (which codified as a threshold), then humans can re-rate additional (y−x) scenarios to use in z-scoring. Otherwise use only x scenarios in z-scoring.

The threshold value for the difference between scores can vary. For example, the threshold value can vary (e.g. 0.25, 0.8) in order for approximately the same number of students to be re-rated under the different scenarios.

In general, the different methods provide similar results.

| Method | MAE | R-squared | ICC | QWK |
|---|---|---|---|---|
| 1 | 0.191 | 0.941 | 0.970 | 0.912 |
| 2 (delta = 0.25) | 0.175 | 0.949 | 0.974 | 0.919 |
| 3 (delta = 0.25) | 0.184 | 0.941 | 0.970 | 0.915 |
| 4 (delta = 0.8) | 0.185 | 0.940 | 0.970 | 0.914 |
| 1 (x = 7) | 0.153 | 0.962 | 0.981 | 0.929 |

For rating, system 100 uses rating service and NLP service 118 to automate scoring to provide an improved scoring process. System 100 can combine automatic scoring with human raters to provide hybrid rating. As noted, system 100 can implement hybrid rating using different methods. Accordingly, rating service can implement hybrid rating.

For example, system 100 can implement hybrid rating using scenario-agnostic methods.

System 100 can train a single model based on historical data and use this model for rating service and NLP service 118 to predict scores.

For each student, system 100 (and its rating service) can set some number of scenarios (Nhumans) to be rated by humans for each student. Assuming there is a fixed total number of scenarios completed by each student (Ntotal), the NAI (=Ntotal−Nhumans) scenarios would be rated by NLP service 118 for each student.

These can be the same or different scenarios (rated by humans and NLP service 118) for each student. System 100 can have a circuit-breaker in the prediction pipeline. If different scenarios are rated by humans for each student, system 100 can use the scenario-specific circuit-breaker. Otherwise, if the same scenarios are rated by humans for each student then the model is used by NLP service 118 to predict ratings for responses to human-rated scenarios. System 100 compares average agreement between AI (e.g. NLP service 118) and human ratings on human-rated scenarios. If statistical thresholds (between human ratings and AI ratings) are not met, then the NLP service 118 is not used at all to make predictions for the test in question. All responses for all remaining unrated scenarios can be sent to humans for rating. Nhumans and NAI, then, are minimum and maximum bounds, respectively, on the number of scenarios rated by humans and AI for each student.

Statistical measures system 100 could use to investigate model training quality are: mean absolute error, root mean square error, intraclass correlation coefficient, quadratic weighted kappa, pearson correlation coefficient, fairness metric. Statistical thresholds can be set in relation to estimated statistical properties of human raters (e.g. interrater reliability for humans).

If statistical thresholds are not met, system 100 can perform hyperparameter tuning to attempt to improve model performance before giving up entirely and turning the rating completely back to humans.

As another example, system 100 can implement hybrid rating using scenario-specific methods.

Rather than training a single model based on historical data to predict scores for responses as they come in, system 100 train unique models for each scenario. NLP service 118 uses the models for generating predictions for scores.

For each scenario, a fraction of students can be selected at random to have their responses rated by human raters. These human-rated responses and scores can then be used to train a model. A fixed model architecture and hyperparameters can be used to minimize training time. Different architectures can be tested and some hyperparameter tuning performed to improve model performance. Training may vary from scenario to scenario. Some scenarios (with more consistent human ratings) require fewer responses for training. Other scenarios (with less consistent human ratings) require more training data. The trained model would then be used by rating service to predict scores for the remaining unrated responses.

Some students can receive ratings from humans (i.e. those in the training set) and the rest of the student will receive automated ratings. System 100 can also have rating service and NLP service 118 predict scores for all responses (including the responses the model was trained on). The model may (at least slightly) do a better job of predicting scores for the responses it was trained on, but (assuming a true random sample for the training data) there should be no bias between predictions on the training and held-out datasets.

System 100 can set some number of scenarios (Nhumans) to be rated by humans for each student. Assuming there is a fixed total number of scenarios completed by each student (Ntotal), then NAI (=Ntotal−Nhumans) scenarios would be automatically rated by AI for each student.

If S students complete a test consisting of Ntotal scenarios, then S Nhumans/Ntotal (rounded to the nearest integer) responses can be used as training data for each scenario.

System 100 can constrain the random sampling to ensure that each student's responses are included in the training data Nhumans times (which may result in some scenarios having one more or one fewer training data point).

System 100 can include a circuit-breaker in the prediction pipeline. If during model training for a scenario, statistical thresholds (between human ratings and AI scores) are not met, then system 100 may not use automated scoring to make predictions for the scenario in question. The remaining responses not used during training can be sent to rater electronic devices to be rated by humans. Nhumans and NAI, then, are minimum and maximum bounds, respectively, on the number of scenarios rated by humans and AI for each student.

Different statistical measures could be use to investigate model training quality. Examples include: mean absolute error; root mean square error; intraclass correlation coefficient; quadratic weighted kappa; pearson correlation coefficient; fairness metric. Statistical thresholds can be set in relation to estimated statistical properties of human raters (e.g. interrater reliability for humans). Model quality can be evaluated on the training dataset, a separate validation dataset, or through cross-validation on the training dataset. If statistical thresholds are not met, system 100 can perform hyperparameter tuning or inject more data into the training dataset to attempt to improve model performance.

System 100 can implement scenario-specific rating that may require that all students have at least one scenario (or a threshold number of scenarios) rated by humans. System 100 can implement scenario-agnostic rating in conjunction with automated rating.

System 100 can use different implementation methods for automated or hybrid ratings.

Once system 100 has ratings for all responses for all scenarios for all students (whether human or AI-rated, scenario-agnostic, or scenario-specific), there are a number of ways system 100 can combine ratings to produce an aggregated score for a student. System 100 can use: conventional hybrid rating, humans-in-the-loop hybrid rating, adaptive rating, AI first rating, and so on.

For the conventional hybrid rating method, the average rating across all scenarios (regardless of whether the rating was provided by a human or AI) is calculated for each student.

For the humans-in-the-loop hybrid rating method, for each student, system 100 compares the mean rating given by human raters (rmean, humans) to an “expected” rating (rexpected). This “expected” rating could be: the mean rating given by AI (rmean, AI); the mean of all ratings given by humans and AI (rmean, total); the mean rating if all scenarios were rated by AI (rmean, AI complete); a predicted rating encompassing human and AI ratings.

If rmean, humans and rexpected differ by at least a certain amount (which can be set by a threshold), then system 100 can flag the student to have responses re-rated. For any flagged student, system 100 could either: send all of their AI-rated responses back to be rated by humans, send back one response (or a subset of AI-rated responses) back to be rated by humans. Then system 100 can compare rmean, humans and rexpected again and either: flag the student to have more responses re-rated by humans or accept that rmean, humans and rexpected are comparable.

Once all flags are resolved, the average rating across all scenarios (regardless of whether the rating was provided by a human or AI) is calculated for each student.

For an example adaptive rating method, for any flagged student, system 100 could either: send all of their AI-rated responses back to be rated by humans, send back one response (or a subset of AI-rated responses) back to be rated by humans. Then system 100 can compare rmean, humans and rexpected again and either: flag the student to have more responses re-rated by humans, or accept that rmean, humans and rexpected are comparable.

Once all flags are resolved, the average rating across only human-rated scenarios is calculated for each student.

For the AI first rating method, all AI-rated responses can be checked by a human who can either: accept the rating assigned by the AI, or assign a new rating to the response.

System 100 can have additional implementation capabilities.

System 100 can implement a secondary predictive model for humans-in-the-loop and adaptive rating. The primary AI model can be trained to predict a rating given a piece of text. System 100 can then train a secondary AI model that predicts whether a student's aggregated score would change based on: the human ratings they have already received and the AI-predicted ratings of any other scenarios from the primary model. The model can take advantage of information at a test-level. For example, if students receive very consistent scores on a subset of scenarios and receive comparable scores on the other remaining scenarios, then for any future student who receives consistent human ratings on the subset of scenarios system 100 might produce an rexpected that is comparable to rmean, humans.

This approach is similar to computer adaptive testing, except students see the same scenarios, and system 100 just chooses whether to rate more based on the information available. The rating is adaptive not the testing.

System 100 can implement prediction intervals. This is similar to models where responses that are challenging for AI to rate are automatically routed to human raters. For each AI-rated response, system 100 can produce a prediction interval (e.g. with 95% confidence we can say that this response deserves a rating between x and y). If that prediction interval is too large (based on a threshold), system 100 can automatically flag that response to be re-rated by humans.

System 100 can implement a gaming flag. In any test where a rater does not see the whole test there are avenues for “gaming” the test. That human raters currently only see one scenario can be seen as both a feature and a bug. If a student uses a mediocre generic response across multiple scenarios, human raters focused on only one scenario may not catch this. System 100 may flag this student though to potentially assign them a lower score or pass along this information to programs. System 100 can use both “similarity detection” software and “content relevance” software to flag students that attempt to game the test.

These tools can be used in conjunction with the rating process.

System 100 can implement similarity detection to identify repeated text by the same student. Similarity detection can also be used to identify text that is borrowed from another source or another person. System 100 can also identify when a student borrows text from a different response during the test.

System 100 can implement content relevance. Content relevance reflects how likely a response would be provided to a question. System 100 can use lexical search, semantic search, and so on to quantify how likely a response would be supplied to a given question. System 100 can flag responses that are overly generic and do not seem to be related to the questions posed.

System 100 can implement human-rating quality assurance. This can involve flagging AI-rated responses for re-rating by humans. System 100 can use AI to flag human-rated responses that should be re-rated by a different human. This may be a continuous feedback loop (AI flagging human responses to be re-rated, humans re-rating AI-rated responses).

System 100 can implement adaptations.

System 100 can implement adaptations for rubrics. The above implementations can be adapted to work with rubrics that assign subscores. Model training would produce a collection of subscores rather than a single score. Circuit-breakers could be deployed for each subscore during training, or for just the aggregated scores. Humans-in-the-loop or adaptive rating could compare aggregated ratings rmean, humans and rexpected as above, or compare component subscores rmean, humans, subscore and rexpected, subscore. If any expected subscore exceeds some threshold, system 100 could flag a student to have their response re-rated by humans, or could specify that some fraction of expected subscores need to exceed a threshold before flagging a student to have their responses re-rated by humans.

System 100 can implement AV responses. System 100 can use different features for AV responses. System 100 can transcribe audio (e.g. using NLP service 118) and produce different types of features. System 100 could also extract: body language, facial expressions, demeanor, or learn features from image stills that correlate with scores.

System 100 can implement response feedback. Regardless of whether system 100 uses AI ratings, system 100 could provide fine-grained feedback on individual responses to students, raters, program administrators, etc. System 100 could highlight or extract different components of a response that reflect: sentiment, subjectivity, tone; elements to be taken into account during rating (either from a rubric or as guiding questions) (e.g. “takes into account multiple perspectives”, “empathizes with others”); aspects that the test is designed to measure (e.g. resilience, ethics, communication). If this tool is used in conjunction with AI-rated responses this could illustrate how each highlighted element contributes to the score assigned by the AI.

This feature could be incorporated into any of the implementation methods above to allow humans to see AI-rated responses and rationale before deciding to accept, reject, or modify the score. Students could take advantage of this tool to understand why they received a certain score on an individual scenario. Raters could take advantage of this tool to get feedback and learn from the AI, which would in turn learn from raters, improving overall rating quality. Administrators could take advantage of this tool to better understand the qualities of applicants that they are considering beyond a single numeric score.

System 100 can implement training for predictive validity. The above implementations can be predicated on an AI model trained to reproduce human ratings of a test. System 100 could also train an AI model to predict a different outcome like an in-program metric using data from students' test responses. The AI ratings can then be optimized to predict the in-program metric or set of metrics. This change in target variable can necessitate the use of a scenario-agnostic model since they would need to use historical data about students' test responses and their relationship with in-program success to build the model.

System 100 can implement quality assurance of raters based on their alignment with AI ratings. System 100 can implement training models based on some gold standard (e.g. best raters) rather than using all raters. System 100 can implement continual evaluation, feature development and maintenance. System 100 can use AI to guide rubric development and how humans rate. System 100 can train models from internal and external data

System 100 can use voice and facial recognition as a security measure. System 100 can monitor video data of test takers using recognition services, such as face detection service 120.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may provide technical effects and solutions such as improved resource usage, improved processing, improved bandwidth usage, redundancy, scalability, and so on.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. A computer system for online testing, the system comprising:
a plurality of client web applications comprising an applicant portal, an administrator portal, a proctor portal, and a rater portal;
a plurality of application services comprising an exam application programming interface service, a content application programming interface service, a proctor application programming interface service, a rating application programming interface service, an administrator application programming interface service, and account application programming interface service;
an application programming interface gateway to transmit messages and exchange data between the plurality of client web applications and the plurality of application services;
a memory and a hardware processor coupled to the memory programmed with executable instructions, the instructions configuring the processor with a plurality of domain services comprising an exam service, a content service, a proctor service, a rating service, an administrator service, and account service;
a message queue service for coordinating messages between the plurality of application services and the plurality of domain services;
wherein the applicant portal is configured to provide a plurality of applicant interfaces to provide an online exam for a plurality of applicants and collect audiovisual response data for the online exam from the plurality of applicant interfaces, wherein the exam service and the exam application programming interface service compile the online exam for the plurality of applicant interfaces, the online exam comprising a test of a collection of scenarios with at least a subset of scenarios being audiovisual response scenarios, wherein the response data is in a response representation format for the audiovisual response scenarios to minimize group differences, wherein the content application programming interface service and the content service delivers content for the exam, the content for the exam comprising audiovisual content, wherein the applicant portal is configured to provide the audiovisual content at the applicant interfaces;
wherein the proctor portal is configured to provide a proctor interface that monitors the applicant portal during the exam; and
wherein the rater portal is configured to provide a plurality of rater interfaces that provides the response data for the exam from the plurality of applicant interfaces and collects rating data from the plurality of rater interfaces for the response data for the exam, wherein the rater portal is configured to compute a rating for the exam for each of the plurality of applicants using the rating data.

2. The system of claim 1 wherein the application services and domain services are implemented by at least one physical machine and at least one worker node, the physical machine providing a plurality of virtual machines corresponding to the plurality of application services, the worker node providing core compute resources and serve functions for the application services and the domain services.

3. The system of claim 1 further comprising an auto-scaling cluster with a control plane network for an auto-scaling controller node group and a data plane network for an auto-scaling worker node group, the control plane network being a set of services running on nodes that communicate with worker nodes of the auto-scaling worker node group, the data plane network providing communication between the services and implementing functionality of the services, wherein the auto-scaling cluster scales nodes of the groups in response to requests by the application services and the domain services, wherein the worker nodes of the worker node group provide core compute resources and serve functions of the services.

4. The system of claim 1 further comprising an authentication service, wherein the applicant portal authenticates the applicant using the authentication service prior to providing the exam to the applicant interface.

5. The system of claim 1 wherein test is a constructed-response test, wherein the response data comprises audiovisual constructed-response data and wherein the applicant portal is configured to collect the audiovisual constructed-response data.

6. The system of claim 5 wherein the rater portal is configured to provide the audiovisual constructed-response data at the rater interface.

7. The system of claim 1 wherein the exam comprises a plurality of scenarios, wherein a first set of response data relates to a first set of scenarios, and a second set of response data relates to a second set of scenarios, wherein the rater portal provides the rater interface with the first set of response data and collects rating data for the first set of response data, wherein the rating service automatically generates the second set of response data using a natural language processing service, wherein the rating service generates a hybrid rating for the applicant using the first set of response data and the second set of response data.

8. The system of claim 1 wherein the rating service uses a natural language processing service to automatically generate rating data for at least a portion of the response data for the exam.

9. The system of claim 1 wherein the proctor service uses a face detection service and/or voice detection service to monitor the exam at the applicant portal.

10. The system of claim 1 wherein the exam involves multiple scenarios, each scenario associated with one or more aspects, each scenario having one or more questions for testing the one or more aspects, each of the one or more questions having one or more corresponding response items of the response data, wherein the rating service generates rating data for a scenario by combining rating data for the corresponding response items to the one or more questions of the respective scenario.

11. The system of claim 1 wherein the exam service defines parameters for exam length required to meet test reliability standards.

12. The system of claim 1 wherein the exam involves at least one scenario having one or more questions and one or more corresponding response items, wherein the exam service converts the one or more questions into a question representation format and the one or more corresponding response items into a response representation format for the audiovisual response scenarios to minimize group differences.

13. The system of claim 1 wherein the rating service computes group difference measurements for the exam by processing the rating data and applicant data, wherein the rating service can define different group difference ranges to indicate negligible, small, moderate and large group differences.

14. The system of claim 1 wherein the exam service provides the audiovisual response scenarios by converting a response format to a constructed audiovisual response format.

15. The system of claim 1 wherein the exam service is configured to compile the exam using exam portal to receive selected scenario and question items for the exam and compile the selected scenario and question items into the exam.

16. The system of claim 1 wherein the proctor service and the proctor portal provide a test support interface to provide test support for applicant portal.

17. A computer system for online testing, the system comprising:
a memory;
one or more processors coupled to the memory programmed with executable instructions, the instructions including a plurality of applicant interfaces, each interface for an online test comprising audiovisual response scenarios, each audiovisual response scenario having one or more corresponding questions, wherein the interface is configured to receive audiovisual response data for the questions, wherein the audiovisual response data is in a response representation format for the audiovisual response scenarios to minimize group differences; and
a plurality of applicant electronic devices, each applicant electronic device having one or more input devices configured to collect the audiovisual response data and having a transmitter for transmitting the collected audiovisual response data to the interface.

18. The system of claim 17 wherein the test is a constructed-response test, wherein the audiovisual response data is audiovisual constructed-response data.

19. The system of claim 17 further comprising a rater electronic device for providing the collected audiovisual response data and collecting rating data corresponding to the audiovisual response data.

20. The system of claim 17 further comprises a rating service to automatically generate at least a portion rating data for the response data.

21-85. (canceled)
